(19) United States
(12) Patent Application Publication
(10) Pub. No.: US 2008/0215301 A1
(43) Pub. Date: Sep. 4, 2008

(54) Method and apparatus for predicting protein structure

(75) Inventors: Eran Eyal, Ramat-HaSharon (IL); Milana Frenkel-Morgenstern, Rechovot (IL); Shmuel Pietrokovski, Rechovot (IL); Vladimir Sobolev, Rechovot (IL); Rachel Shakarov, Petach-Tikva (IL)

Correspondence Address: Martin D. Moynihan;PRTSI, Inc., P.O. Box 16446, Arlington, VA, 22215, US

(73) Assignee: Yeda Research and Development Co. Ltd., Rehovot (IL)

(21) Appl. No.: 11/802,365

(22) Filed: May 22, 2007

Related U.S. Application Data
(60) Provisional application No. 60/802,105, filed on May 22, 2006.

(51) Int. Cl. G06F 19/00

(52) U.S. Cl. 703/11

(57) ABSTRACT

A method of determining predicting putative contacting sites of a target protein is disclosed. The method uses a substitution matrix for calculating contact probabilities for pairs of columns in a sequence alignment containing the amino acid sequence of the target protein. The contact probabilities can also be used for predicting the three-dimensional structure of the protein. The putative contacts and/or three-dimensional structure typically correspond to the hydrophobic core of the target protein.

### RELATED APPLICATION

This Application claims the benefit of U.S. Provisional Patent Application No. 60/802,105 filed May 22, 2006, the contents of which are hereby incorporated by reference.

### FIELD AND BACKGROUND OF THE INVENTION

The present invention relates to bioinformatics and, more particularly, to apparatus and method for predicting, recognizing and/or designing a three-dimensional structure of a protein from a sequence alignment.

Informatics is the study and application of computer and statistical techniques for the management of information. In Genome projects, bioinformatics includes the development of methods to search databases fast and efficiently, to analyze nucleic acid sequence information and to predict protein primary, secondary and tertiary structures from DNA sequence data. Increasingly, molecular biology is shifting from the laboratory bench to the computer desktop. Advanced quantitative analyses, database comparisons and computational algorithms are needed to explore the relationships between sequence, structure and phenotype. However, a successful analysis has to better deal with the problem of predicting, recognizing and/or designing of three-dimensional protein structures.

Proteins are linear polymers of amino acids. The polymerization reaction (synthetic or natural), which produces a protein, results in the loss of one molecule of water from each peptide bond formed (linking two adjacent amino acids. Natural protein molecules may contain as many as 22 different types of amino acid residues, the sequence of which defines the so-called “primary sequence” of the protein. Proteins fold into a three-dimensional structure, which is determined both by the sequence of amino acids and by the protein's environment. Examination of the three-dimensional structure of numerous natural proteins has revealed a number of recurring patterns, the most common are known as alpha helices, parallel beta sheets and anti-parallel beta sheets, which define a second level of structural organization. The amino acids, the peptide bond and the above structures are further described in many biology text books, including, for example, in “Biochemistry”, third edition, L. Stryer, W. H. Freeman and Company, NY.

Elucidating the three dimensional structure of a protein (or at least long-ranged contacting points within the amino acids of the protein) is key to understanding the function of a protein in the cell, or to understanding how particular molecular targets (which are, in most cases, proteins) interact with drugs. Furthermore, knowledge of the 3D structure of a protein is also key to understanding how binding of a ligand (including drugs) changes the behavior of that protein. This knowledge can also aid the understanding of how particular mutations or variations in the gene that encodes a particular protein lead to changes in the protein's behavior that can result in disease or in differences in drug interactions among different individuals. The 3D conformation of a target will be critical in determining whether the target is even a subject for drug design and, if it is, which compounds will have the best fit based on this conformation.

Current methods of determining protein structure include X-ray crystallography, neutron and electron diffractions and nuclear magnetic resonance. However, these methods while being reliable, are highly laborious, time consuming and cumbersome. In the past, the number of known protein sequences was small and, therefore, the need for efficient methods for protein structure prediction was minute and was accomplishable manually. The need for highly efficient methods has become evident with the significant increase in the number of entries in protein sequence databases, as well as with the progress of the structural Genomics efforts.

Currently available algorithms for predicting protein structure are based on the primary sequence of the protein. However, these algorithms make correct predictions only in limited number of cases in which the number of available homologous proteins is sufficiently large.

The problem of determining the three-dimensional structure of a protein from its primary structure, has defied solution for over decades. One of the earliest methods for predicting the three-dimensional structure of a protein is known as homology modeling. Homology modeling is applicable only for cases in which three-dimensional structures of similar sequences are already known. In this technique, a three-dimensional model for a protein of unknown structure (the target) is constructed based on one or more related proteins of known structure (the templates). The necessary conditions for getting a useful model are (i) detectable similarity and (ii) availability of a correct alignment between the target amino acid sequence and the template structures. Homology modeling is based on the notion that new proteins evolve gradually by amino acid substitution, addition and/or deletion, and that the three-dimensional structures and functions are often strongly conserved during the evolution. In homology modeling, structural similarity is assumed between two proteins if there exists a sufficient similarity (typically at least 35%) between the proteins at the sequence level.

As a result of the molecular biology revolution, the number of known protein sequences is many times greater than the number of known three-dimensional protein structures. The increase in the number of known protein sequences, and the fact that many sequences have been found to fold into the same basic three-dimensional structure, have lead the community to the hypothesis that nature is apparently restricted to a limited number of protein folds. Protein structure prediction can therefore be reduced to a simpler problem of identifying which of the known three-dimensional structures in a database is adopted by a given primary structure. This type of three-dimensional structure prediction is called threading or fold recognition.

Generally, threading or fold recognition methods compare a target amino acid sequence against a library of structural templates, producing a list of scores. The scores are ranked and the fold with the best score is assumed to be the one adopted by the amino acid sequence. Threading or fold recognition is based on the theory that for a given amino acid sequence, there is only a limited number of distinct protein folds. Broadly speaking, threading or fold recognition involves pairwise comparison of a protein amino acid sequence and a protein structure; that is, structural information is used for one of the two proteins that are being compared, and the target amino acid sequence is threaded through a library of three-dimensional structures. The scores are produced using an energy function which evaluates the fit between the target amino acid sequence and the library entries. Threading methods are particularly useful when there are not enough known sequences having significant relation to the protein in question.

Both threading and homology modeling belong to the group of knowledge based techniques which attempt to relate an amino acid sequence to three-dimensional structures already determined experimentally by various structural methods.

Structure prediction methods in which the three-dimensional structure of the protein is predicted solely from its sequence information are commonly termed ab initio methods. Ab initio methods do not rely on similarity at the fold level between the modeled sequence and any of the known structures. Ab initio methods assume a form of free energy function and simulate its evolution by traversing the space of possible conformations of the protein in question. The three-dimensional structure of the protein corresponds to a global minimum of its free energy. For practical reasons, most ab initio prediction methods use reduced representations of the protein so as to limit the conformational space to manageable size, and use empirical energy functions that capture the most important amino acid interactions governing the folding of the protein toward its three-dimensional structures.

The problem of protein folding is related to the problem of predicting residue-residue contacts within proteins. It is recognized that confident knowledge of only several contacts in a given protein sequence is sufficient to substantially predict the three-dimensional structure of the protein. Over the past decade, many attempts have been made to develop computational methods for predicting protein residue-residue contacts from sequence information. Most known residue-residue contacts prediction methods use correlated mutation analysis to seek for pairs of sites with co-varying amino acids.

Generally, these methods use phylogenetic information to seek simultaneous mutation events, which are more likely to be due to real structural/functional correlations. Despite the strong statistical background of the different methods, contact prediction accuracy by means of correlated mutations is, in general, relatively low. This is not unexpected because this problem, as mentioned, is equivalent to the protein folding problem, which is known to be NP hard.

Also known are methods which employ substitution matrices to calculate correlation coefficients from multiple sequence alignments. Generally, these methods assume that most proteins in the multiple alignment have the same overall structural fold and that most pairs of residues in two aligned columns are either contacting or non-contacting. Many types of substitution matrices for contacts prediction are known, including binary identity matrices, knowledge based matrices, biophysical complementarity matrix and contact potential matrices. Most substitution matrices used for correlated mutation analysis are solely based on sequence information.

Of relevance to the present invention is a method in which coupled protein residues are identified from multiple sequence alignments (to this end see, e.g., Russ et al. “Natural-like function in artificial WW domains”, Nature, 2005, 437(7058):579-583; Socolich et al. “Evolutionary information for specifying a protein fold”, Nature, 2005, 437:512-518 and Hatley et al. “Allosteric determinants in guanine nucleotide-binding proteins”, Proceedings of the National Academy of Sciences, 2003, 100:14445-14450). Although successfully applied to identify allosteric interactions and to design proteins of a given fold and activity, this method requires large and diverse multiple alignments and is not specifically oriented to detect residues in direct contact, finding other co-evolving residues.

Sophisticated methods were also developed to integrate basic contact prediction for individual sites with the location of sites in the primary, secondary and tertiary structures of proteins. Such methods use the relative positions of the predicted contacts to each other, the predicted secondary structure and the contact potentials as training data for machine learning. Although providing significant improvement, these methods are still limited by the low accuracy of contact prediction between any two given sites.

It is recognized that substitution matrices can be significantly improved if constructed using both sequence and structure information. For example, known in the art is a method which combines correlated mutations with statistically derived information from the HSSP database of structurally known proteins [Thomas et al., “The prediction of protein contacts from multiple sequence alignments”, Protein Engineering, 1996, 9(11):941-948]. The method calculates the likelihood of a pair of residues being in contact, based on the type of the residues and information on mutational behavior extracted from the database.

Another method calculates the overall scores between pairs of multiple-sequence alignment columns using a correlation operator [Singer et al., “Prediction of protein residue contacts with a PDB-derived likelihood matrix”, Protein Engineering, 2002, 15:721-725]. The overall scores are used for constructing residue-residue contact matrix. This method, however, can only complement, rather then replace, other correlated mutation analysis. In particular, this method fails to use information regarding phylogenetic relations, chain separation, cellular/extracellular localization and the like.

The present invention provides solutions to the problems associated with the prior art techniques for predicting protein structure.

### SUMMARY OF THE INVENTION

According to one aspect of the present invention there is provided a method of predicting putative contacting sites of a target protein. The method comprises: providing a substitution matrix representing predetermined probabilities for amino acid pair substitutions; providing a sequence alignment containing at least a portion of the amino acid sequence of the target protein; and utilizing the substitution matrix for calculating contact probabilities for pairs of columns in the sequence alignment, thereby predicting the putative contacting sites of at least a first portion of the target protein, the first portion corresponding to a hydrophobic core of the target protein.

According to further features in preferred embodiments of the invention described below, the method further comprises applying a supplementary algorithm for predicting putative contact sites of at least a second portion of the target protein, the second portion being other than the first portion.

According to still further features in the described preferred embodiments the method further comprises, using the putative contacting sites for predicting at least a partial three-dimensional structure of the target protein.

According to still further features in the described preferred embodiments the partial three-dimensional structure corresponds to the hydrophobic core.

According to still further features in the described preferred embodiments the method further comprises using the putative contact sites of the at least a second portion of the target protein for predicting a three-dimensional structure of the second portion of the target protein.

According to still further features in the described preferred embodiments the utilization of the substitution matrix comprises: constructing a graph having a plurality of nodes, each corresponding to an individual amino acid, and a plurality of edges, each corresponding to a contact between two respective amino acids; analyzing the graph so as to locate highly connected regions over the graph; and predicting the at least the first portion of the three-dimensional structure based on the highly connected regions.

According to another aspect of the present invention there is provided apparatus for predicting putative contacting sites of a target protein. The apparatus comprises an input unit, inputting a sequence alignment containing at least a portion of the amino acid sequence of the target protein; a contact probability calculation unit, capable of accessing a substitution matrix representing predetermined probabilities for amino acid pair substitutions, the contact probability calculation unit being operable to utilize the substitution matrix for calculating contact probabilities for pairs of columns in the sequence alignment; and a contact prediction unit, for using the contact probabilities to predict the putative contacting sites of at least a first portion of the target protein, the first portion corresponding to a hydrophobic core of the target protein.

According to further features in preferred embodiments of the invention described below, the apparatus further comprises a supplementary unit operable to apply a supplementary algorithm for predicting putative contact sites of at least a second portion of the target protein, the second portion being other than the first portion.

According to yet another aspect of the present invention there is provided apparatus for predicting at least a partial three-dimensional structure of a target protein. The apparatus comprises an input unit for inputting a sequence alignment containing at least a portion of the amino acid sequence of the target protein; and a contact probability calculation unit, capable of accessing a substitution matrix representing predetermined probabilities for amino acid pair substitutions, the contact probability calculation unit being operable to utilize the substitution matrix for calculating contact probabilities for pairs of columns in the sequence alignment, so as to predict at least a first portion of the three-dimensional structure of the target protein, the first portion corresponding to a hydrophobic core of the target protein.

According to further features in preferred embodiments of the invention described below, the apparatus further comprises a supplementary unit operable to apply a supplementary algorithm for predicting three-dimensional structure of at least a second portion of the target protein, the second portion being other than the first portion.

According to still further features in the described preferred embodiments the apparatus further comprises a graph constructor, for constructing a graph having a plurality of nodes, each corresponding to an individual amino acid, and a plurality of edges, each corresponding to a contact between two respective amino acids, the graph constructor being associated with a graph analysis functionality, for locating highly connected regions over the graph and predicting the at least the first portion of the three-dimensional structure based on the highly connected regions.

According to further features in preferred embodiments of the invention described below, the sequence alignment comprises an amino acid sequence of a protein having a known three-dimensional structure.

According to still further features in the described preferred embodiments the protein is homologous or orthologous to the target protein.

According to still further features in the described preferred embodiments the sequence alignment comprises two sequences.

According to still further features in the described preferred embodiments the substitution matrix is utilized for calculating probabilities for substituting contacting pairs of the amino acid sequence with respectively aligned pairs of the target amino acid sequence.

According to still further features in the described preferred embodiments the contacting pairs occupy at least a hydrophobic core of the known three-dimensional structure of the protein.

According to still another aspect of the present invention there is provided a method of designing at least a portion of a protein having a target three-dimensional structure, comprises: providing a substitution matrix representing predetermined probabilities for amino acid pair substitutions; reducing the substitution matrix to a residue-residue contact matrix; generating a query amino acid sequence; utilizing the residue-residue contact matrix for iteratively updating the query amino acid sequence to ensure that the query amino acid sequence comprises contactable pairs corresponding to contacting points characterizing at least a first portion of the target three-dimensional structure, the first portion corresponding to a hydrophobic core of the target three-dimensional structure.

According to further features in preferred embodiments of the invention described below, the method further comprises applying a supplementary algorithm for iteratively updating the query amino acid sequence to ensure that the query amino acid sequence comprises contactable pairs corresponding to contacting points characterizing at least a second portion of the target three-dimensional structure, the second portion being other than the first portion.

According to still further features in the described preferred embodiments the utilization of the substitution matrix comprises: constructing a graph having a plurality of nodes, each corresponding to an individual amino acid, and a plurality of edges, each corresponding to a contact between two respective amino acids; analyzing the graph so as to locate highly connected regions over the graph; and updating the query amino acid based on the highly connected regions.

According to an additional aspect of the present invention there is provided apparatus for designing at least a portion of a protein having a target three-dimensional structure. The apparatus comprises: an input unit for inputting the target three-dimensional structure; an amino acid sequence generator for generating a query amino acid sequence; a matrix reduction unit capable of accessing a substitution matrix representing predetermined probabilities for amino acid pair substitutions, and reducing the substitution matrix to a residue-residue contact matrix; a sequence updating unit, operable to utilize the residue-residue contact matrix for iteratively updating the query amino acid sequence to ensure that the query amino acid sequence comprises contactable pairs corresponding to contacting points characterizing at least a first portion of the target three-dimensional structure, the first portion corresponding to a hydrophobic core of the target three-dimensional structure.

According to further features in preferred embodiments of the invention described below, the apparatus further comprises a supplementary unit operable to apply a supplementary algorithm for iteratively updating the query amino acid sequence to ensure that the query amino acid sequence comprises contactable pairs corresponding to contacting points characterizing at least a second portion of the target three-dimensional structure, the second portion being other than the first portion.

According to still further features in the described preferred embodiments the apparatus further comprises a graph constructor, for constructing a graph having a plurality of nodes, each corresponding to an individual amino acid, and a plurality of edges, each corresponding to a contact between two respective amino acids, the graph constructor being associated with a graph analysis functionality, for locating highly connected regions over the graph, wherein the sequence updating unit is configured to update the query amino acid based on the highly connected regions.

According to further features in preferred embodiments of the invention described below, the query sequence contains at least 20 columns.

According to yet an additional aspect of the present invention there is provided a method of predicting putative interaction sites between a first protein having a first amino acid sequence and a second protein having a second amino acid sequence, comprises: providing a substitution matrix representing predetermined probabilities for amino acid pair substitutions; and utilizing the substitution matrix for calculating probabilities corresponding to contacts between pairs of the first amino acid sequence and pairs of the second amino acid sequence, thereby predicting the putative interaction sites between the first protein and the second protein.

According to further features in preferred embodiments of the invention described below, the method further comprises providing a first sequence alignment containing at least a portion of the first amino acid sequence, and a second sequence alignment containing at least a portion of the second amino acid sequence, wherein the substitution matrix is utilized for calculating contact probabilities for pairs of columns in at least one of the first and the second sequence alignments, so as to predict three-dimensional structure of the first protein and/or the second protein.

According to still further features in the described preferred embodiments the utilization of the substitution matrix comprises constructing a graph having a plurality of nodes, each corresponding to an individual amino acid, and a plurality of edges, each corresponding to a contact between an amino acid of the first amino acid sequence and an amino acid of the second amino acid sequence; analyzing the graph so as to locate highly connected regions over the graph; and calculating the probabilities based on the highly connected regions.

According to still an additional aspect of the present invention there is provided apparatus for predicting putative interaction sites between a first protein having a first amino acid sequence and a second protein having a second amino acid sequence, comprises a probability calculation unit, capable of accessing a substitution matrix representing predetermined probabilities for amino acid pair substitutions, the probability calculation unit being operable to utilize the substitution matrix for calculating probabilities corresponding to contacts between pairs of the first amino acid sequence and pairs of the second amino acid sequence.

According to further features in preferred embodiments of the invention described below, the apparatus further comprises an input unit, for inputting a first sequence alignment containing at least a portion of the first amino acid sequence, and a second sequence alignment containing at least a portion of the second amino acid sequence, wherein the probability calculation unit is operable to calculate contact probabilities for pairs of columns in at least one of the first and the second sequence alignments, so as to predict three-dimensional structure of the first protein and/or the second protein.

According to still further features in the described preferred embodiments the apparatus further comprises a graph constructor, for constructing a graph having a plurality of nodes, each corresponding to an individual amino acid, and a plurality of edges, each corresponding to a contact between two respective amino acids, the graph constructor being associated with a graph analysis functionality, for locating highly connected regions over the graph, wherein the probability calculation unit is configured to calculate the probabilities based on the highly connected regions.

According to still further features in the described preferred embodiments at least one of the first protein and the second protein has a known three-dimensional structure.

According to still further features in the described preferred embodiments each edge of the plurality of edges is associated with a weight, hence the graph is a weighted graph.

According to still further features in the described preferred embodiments the analysis of the graph comprises updating at least one weight of the graph. According to still further features in the described preferred embodiments the updating is by a moving window procedure. According to still further features in the described preferred embodiments the analysis of the graph is iterated at least one.

According to a further aspect of the present invention there is provided a readable data storage medium, carrying a substitution matrix. The substitution matrix comprises a plurality of matrix-elements, each representing a probability for substituting a first respective pair of amino acids with a second respective pair of amino acids, wherein the average of all probabilities represented by matrix-elements corresponding to contacting pairs of amino acids is above a first threshold and the average of all probabilities represented by matrix-elements corresponding to conserved pairs of amino acids is below a second threshold being lower than the first threshold. A contact between two pairs of amino acids of at least one protein sequence is predictable by extracting a probability represented by a respective matrix-element of the substitution matrix and using the probability for predicting the contact between the two pairs of amino acids.

According to still a further aspect of the present invention there is provided a system, which comprises the readable data storage medium and a data processor. The data processor accesses the substitution matrix and predicts a contact between two pairs of amino acids of at least one protein sequence by extracting a probability represented by a respective matrix-element of the substitution matrix and using the probability for predicting the contact.

According to yet a further aspect of the present invention there is provided a method of ranking decoy structures of a protein having a known sequence, comprises: providing a substitution matrix representing predetermined probabilities for amino acid pair substitutions; providing a sequence alignment containing at least a portion of the amino acid sequence of the target protein; and utilizing the substitution matrix for assigning a score for each decoy structure, thereby ranking the decoy structures of the protein having.

According to still a further aspect of the present invention there is provided apparatus for ranking decoy structures of a protein having a known sequence, comprises: an input unit, for inputting a sequence alignment containing at least a portion of the amino acid sequence of the target protein; a score calculation unit, capable of accessing a substitution matrix representing predetermined probabilities for amino acid pair substitutions, the score calculation unit being operable to utilize the substitution matrix for assigning a score for each decoy structure.

According to further features in preferred embodiments of the invention described below, the substitution matrix comprises a plurality of matrix-elements, and wherein matrix-elements corresponding to conserved amino acids represent low probabilities.

According to still further features in the described preferred embodiments the sequence alignment comprises at least three sequences.

According to still further features in the described preferred embodiments the method further comprises association each sequence of the at least three sequences with a weight, thereby providing a weighted sequence alignment characterized by a plurality of weights.

According to still further features in the described preferred embodiments the apparatus further comprises a weighting unit for association each sequence of the at least three sequences with a weight, thereby to provide a weighted sequence alignment characterized by a plurality of weights.

According to still further features in the described preferred embodiments the contact probabilities are calculated using at least a portion of the plurality of weights.

According to still further features in the described preferred embodiments the sequence alignment contains at least 10 sequences. According to still further features in the described preferred embodiments the sequence alignment contains at least 20 columns, preferably between about 40 and about 80 columns, say about 60 columns.

According to still further features in the described preferred embodiments the supplementary algorithm comprises residue-residue contacts prediction.

According to still further features in the described preferred embodiments the supplementary algorithm comprises correlated mutation analysis.

According to still further features in the described preferred embodiments the supplementary algorithm comprises Monte Carlo folding simulations.

According to still further features in the described preferred embodiments the supplementary algorithm is capable of utilizing a supplementary substitution matrix.

According to still further features in the described preferred embodiments the supplementary substitution matrix is a binary matrix.

According to still further features in the described preferred embodiments the supplementary substitution matrix is a blocks substitution matrix.

According to still further features in the described preferred embodiments the supplementary substitution matrix is a biophysical complementarity matrix.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-b are schematic illustrations of portions of a pair-to-pair substitution matrix, according to various exemplary embodiments of the present invention.

FIGS. 1c-d are histograms of the matrix-elements shown in FIGS. 1a-b, respectively. The horizontal axis is proportional to the number of matrix-elements, where each major tick mark on the axis corresponds to ten histogram units and each histogram unit represents a value of 0.689 in FIG. 1c and 0.422 in FIG. 1d.

FIG. 2a is a simplified illustration of a multiple sequence alignment.

FIG. 2b is a flowchart diagram of a method for predicting putative contacting sites in a target protein, according to various exemplary embodiments of the present invention.

FIG. 3 is a simplified illustration of an apparatus for predicting putative contacting sites, according to various exemplary embodiments of the present invention.

FIG. 4 is a flowchart diagram of a method suitable for predicting at least a partial three-dimensional structure of a target protein, according to various exemplary embodiments of the present invention.

FIG. 5 is a schematic illustration of an apparatus for predicting at least a partial three-dimensional structure of a target protein, according to various exemplary embodiments of the present invention.

FIG. 6 is a flowchart diagram of a method suitable for designing at least a portion of a protein, according to various exemplary embodiments of the present invention.

FIG. 7 is a schematic illustration of an apparatus for designing at least a portion of a protein, according to various exemplary embodiments of the present invention.

FIG. 8 is a flowchart diagram of a method suitable for predicting interaction sites between two or more proteins, according to various exemplary embodiments of the present invention.

FIG. 9 shows relation between scores for pairs of core residues as calculated according to a preferred embodiment of the present invention and their actual distance.

FIGS. 10a-b show examples of contact prediction, obtained in accordance with preferred embodiment of the present invention for two protein families.

FIGS. 11a-b show a comparison between predictions obtained in accordance with preferred embodiment of the present invention method and predictions obtained according to the prior art.

FIG. 12 shows mean contact prediction accuracy in proteins core, obtained in accordance with preferred embodiment of the present invention for proteins with different maximal lengths.

FIG. 13 shows evaluation of decoy structure sets according to preferred embodiments of the present invention.

FIG. 14 is a schematic illustration of graph which can be used for predicting contacts and/or three-dimensional structure, according to various exemplary embodiments of the present invention.

FIG. 15 is a schematic illustration of a procedure for calculation a mutual clustering coefficient, according to various exemplary embodiments of the present invention.

FIG. 16 is an image of a graphical analysis environment provided by a prototype apparatus in accordance with various exemplary embodiments of the present invention.

### DESCRIPTION OF THE PREFERRED EMBODIMENTS

The present embodiments comprise method and apparatus which can be used for various types of protein structure analyses. Specifically, but not exclusively, the present embodiments can be used to predict, recognize and/or design a three-dimensional structure of a protein. The present embodiments further comprise a pair to pair substitution matrix which can be used to predict, recognize and/or design the three-dimensional structure of the protein.

The principles and operation of a method and apparatus according to the present invention may be better understood with reference to the drawings and accompanying descriptions.

Before explaining at least one embodiment of the invention in detail, it is to be understood that the invention is not limited in its application to the details set forth in the following description or exemplified by the examples. The invention is capable of other embodiments or of being practiced or carried out in various ways. Also, it is to be understood that the phraseology and terminology employed herein is for the purpose of description and should not be regarded as limiting. Further it is to be understood that, unless otherwise defined, the method steps described hereinbelow can be executed either contemporaneously or sequentially in many combinations or orders of execution. Specifically, the ordering of the flowcharts in various drawings described below is not to be considered as limiting. For example, two or more method steps, appearing in the following description or in a particular flowchart in a particular order, can be executed in a different order (e.g., a reverse order) or substantially contemporaneously.

In a search for a method and apparatus for predicting, recognizing and/or designing three-dimensional protein structures, the present inventors have devised an amino acids pair-to-pair substitution matrix, referred to herein as P2PMAT.

Generally, the matrix-elements of P2PMAT represent probabilities for substituting (replacing) pairs of amino acids. P2PMAT is typically a square matrix whose number of rows (and columns) equals the number of amino acid pairs represented by the matrix. For N types of amino acids, there are N² different pairing combinations. Thus, for N types of amino acids, P2PMAT preferably includes N⁴ matrix-elements, arranged in N² rows and N² columns. For example, when P2PMAT represents 20 types of amino acids, it includes 160,000 elements arranged in 400 rows and 400 columns.

The pair-to-pair substitution matrices can be constructed for protein in general or for specific sub groups. For example, for different specific protein families, for proteins of specific organisms (e.g., hyper-halophilic prokaryotes, mammals, viruses), for specific regions of proteins such as core protein regions, trans-membranal regions, alpha helices, extra-cellular protein regions etc., Some features could be combined for example, extra cellular regions of hyper-halophiles. These matrices can then be used to predict and/or analyze types of specific organisms, protein families or features from which they are constructed.

The amino acids pair-to-pair substitution matrix of the present embodiments can be embodied in any electronically readable data storage medium, including, without limitation, a memory medium (e.g., RAM, ROM, EEPROM, flash memory, etc.), an optical storage medium (e.g., CD-ROM, DVD, etc.), a magnetic storage medium (e.g., magnetic cassettes, magnetic tape, magnetic disk storage device, etc.), or any other medium which can be used to store the matrix and which can be accessed electronically, e.g., by a data processor. The matrix of the present embodiments can also be embodied on a printed medium, e.g., a paper.

Representative examples of amino acids pair-to-pair substitution matrices are provided in readable files P2Pmat.txt, P2Pmat14Inter.txt, P2Pmat14Intra.txt and P2Pmat14Burried.txt embodied in enclosed CD-ROM 1.

In standard mathematical notations, a matrix-element of a matrix M is denoted M_{ρσ}, where ρ is typically the row index and σ is typically the column index. As will be appreciated by one of ordinary skill in the art, the amino acids pair-to-pair substitution matrix of the present embodiments is better characterized by a pair of indices for each row and a pair of indices for each column. Specifically, the ρth row is represented by a two indices [xy] corresponding the pairing of amino acid x and amino acid y, and the σth column is represented by two indices [uv] corresponding to the pairing of amino acid u and amino acid v. Thus, the matrix-element M_{[xy][uv]} of P2PMAT represents the probability for substituting the amino acids pair (x,y) with the amino acids pair (u,v). In terms of protein evolution, M_{[xy][uv]} of represents the probability for the (double) evolutionary transition x→u and y→v. Preferably, P2PMAT possesses some kind of symmetry such that the same probability is attributed to the inverse transition u→x and v→y. Other symmetry considerations are provided hereinafter.

The probabilities represented by P2PMAT can be stored either explicitly or implicitly in the matrix-elements of P2PMAT. In other words, the value stored in each matrix-element M_{[xy][uv]} of P2PMAT can be a probability or a function of a probability. In the latter case, the function of a probability is preferably invertible so as to allow the user to extract probabilistic information from the matrix.

As further detailed hereinunder, P2PMAT is constructed from a large database of high quality multiple sequence alignments of conserved protein regions and many known protein structures. As such, the entries of P2PMAT embody a considerable amount of fold information, although the matrix-elements themselves are addressable solely by sequence information. Specifically, whereas a particular matrix-element is addressed by its row index (ρ≡[xy]) and column index [σ≡[uv]), which are purely primary sequence entities, the numerical value associated with the matrix-element reflects fold information. Thus, unlike most available methods aiming to detect correlated sites in proteins, P2PMAT is oriented to detect sites in direct contact, and is derived from protein structures including observed information regarding residue-residue contacts.

Whether the probabilities are stored explicitly or implicitly, P2PMAT preferably represents higher probabilities for the substitution of contacting amino acid pairs and low probabilities for the substitution of non-contacting amino acid pairs. According to a preferred embodiment of the present invention the average of all probabilities represented by matrix-elements corresponding to contacting pairs is above a first threshold, t₁. For example, suppose that x₁ and y₁ are two amino acid residues which are likely to be in contact. Suppose further that in some evolutionary process x₁ is transformed into u₁ and y₁ is transformed into v₁ such that u₁ and v₁ remain in contact. In this case, the corresponding matrix-element M_{ρσ} (with ρ=[x₁y₁] and σ=[u₁v₁]) represents a probability which is often larger than t₁. A typical value for t₁ is, without limitation, above 0.2)

Thus, if two probabilities P₁ and P₂ which are respectively represented by two different matrix-elements M_{ρσ} and M_{αβ}, satisfy P₁>P₂, the likelihood that the evolution process occurs at contacting sites is larger for the two pairs in M_{ρσ} than for the two pairs in M_{αβ}.

While conceiving the present invention it has been hypothesized and while reducing the present invention to practice it has been realized that invariance of amino acids in two sites (x,y [symbol] x,y), although suggesting structural/functional role for each of the sites, is not very informative regarding a potential contact between them. Thus, in various exemplary embodiments of the invention the average of all probabilities represented by matrix-elements corresponding to conserved pairs of amino acids is below a second threshold, t₂. A typical value for t₂ is, without limitation, about 0.1, more preferably about 0.08, most preferably about 0.05.

As used herein the term “about” refers to ±10%.

The low probabilities which are given to conserved pairs are not obvious and are conceptually different from the behavior of traditional substitution matrices, which are known to give high scores to conserved substitutions.

Although, in general, conserved pairs are assigned with low probabilities, there are some situations, in which particular conserved pairs are assigned with higher probabilities. For example, it is known that contacting pairs which interact via a disulfide bond can only be formed by a pair of cysteine residues. According to a preferred embodiment of the present invention matrix-elements corresponding to this conserved pair represent higher probabilities than matrix-elements corresponding to other conserved pairs. Typical contact log likelihood probabilities for matrix-element representing conserved pair of Cys residues are about 1.41. Other examples of conserved pairs assigned with higher probabilities, include (His,Cys) and (His,His), which are known to bind through metal binding. Since the two residues bind the same metal atom they are more likely to contact each other due to their nearby location. Typical contact log likelihood probabilities for matrix-element representing such conserved pair are, without limitation, about 0.85 for a conserved (His,Cys) pair, and about 1.33 for a conserved (His,His) pair. This shows that the matrix of the present embodiments combines information regarding conservation and correlation in a natural way.

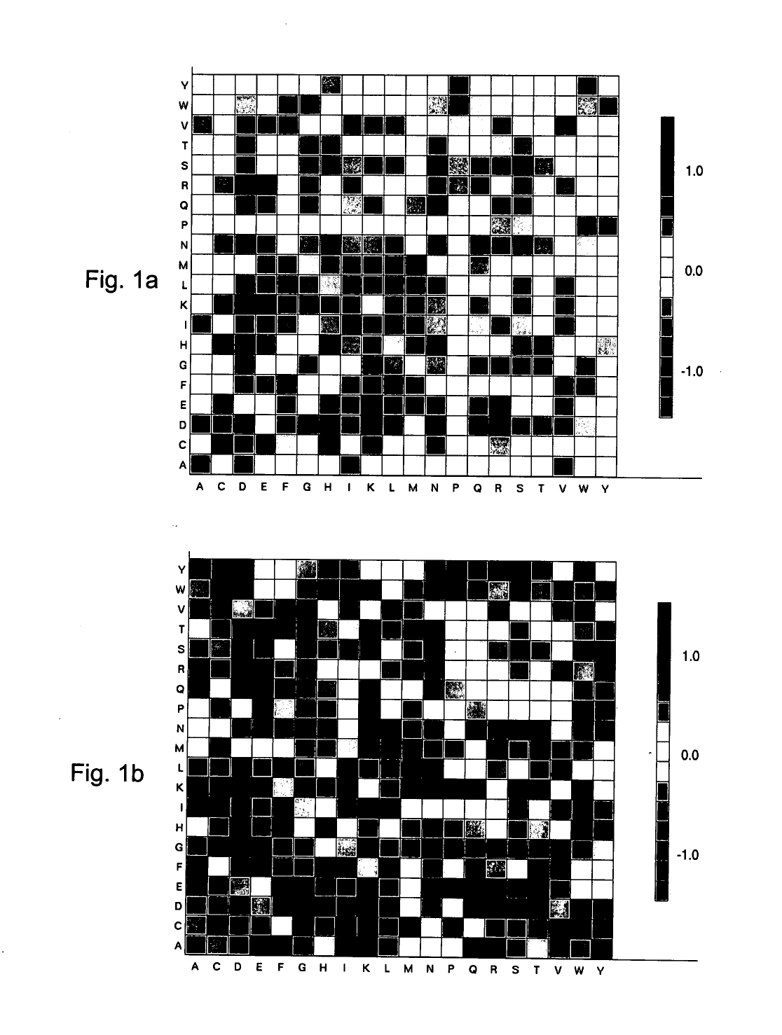

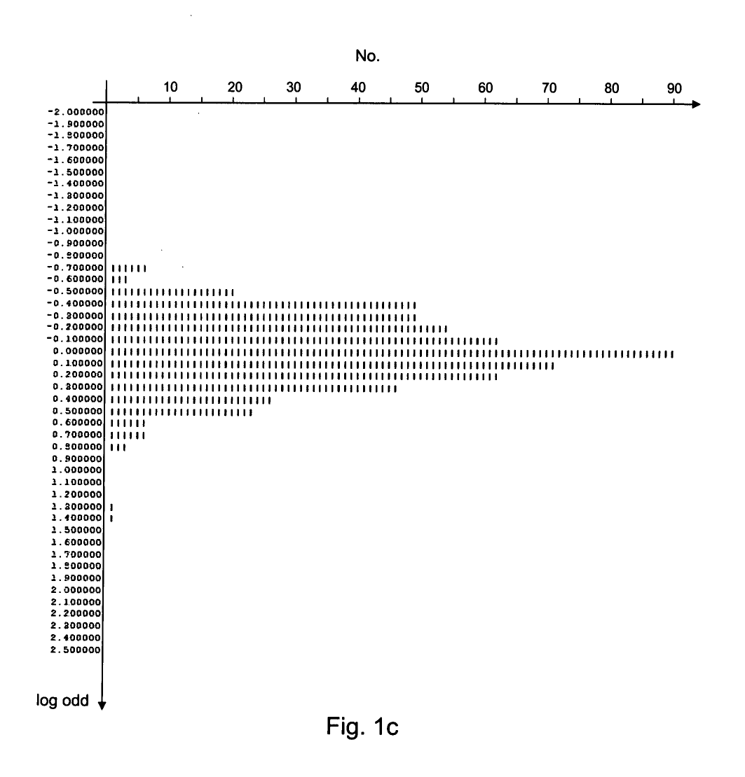

Referring now to the drawings, FIGS. 1a-b are schematic illustrations of portions of a pair-to-pair substitution matrix, constructed for 20 types of amino acids, according to various exemplary embodiments of the present invention. For 20 types of amino acids there are 160,000 matrix-elements in P2PMAT, of which 400 are “invariant” or “diagonal” matrix-elements (with identical row and column indices, e.g., M_{[xy][xy]}) and 159,600 “transitional” or “off-diagonal” matrix-elements (non-identical row and column indices, e.g., M_{[xy][uv]}, where x≠u and/or y≠v). The matrix-elements shown in FIG. 1a-b include the 400 “invariant” matrix-elements and 400 of the 159,600 “transitional” matrix-elements. The shown “transitional” matrix-elements represent symmetric transitions in which the first member of the pair is transformed to the second member of the pair and vice versa (x,y [symbol] y,x). Such symmetric transitions are referred to hereinafter as flips.

The matrix-elements are arranged in FIGS. 1a-b as two 20×20 blocks. The block illustrated in FIG. 1a exemplifies the “invariant” matrix-elements M_{[xy][xy]}, and the block illustrated in FIG. 1b exemplifies “flipped” matrix-elements M_{[xy][yx]}. The 20×20 blocks shown in FIG. 1a-b include matrix-elements which store log odds rather than simple probabilities. For the clarity of presentation, the (log odd) value associated with each matrix-element is presented in a distinctive color according to a color code shown on the right hand side of each figure (from red for the low log odds to blue for the high log odds). Histograms of the invariant matrix-elements M_{[xy][xy]} and flipped matrix-elements M_{[xy][yx]} are shown in FIGS. 1c and 1d, respectively. The vertical axis in FIGS. 1c and 1d presents log odds values and the horizontal axis presents values which are proportional to the number of matrix-elements storing the respective log odds values. Each major tick mark on the horizontal axis corresponds to ten histogram units, where each histogram unit represents a value of 0.689 in FIG. 1c and 0.422 in FIG. 1d.

As will be appreciated by one ordinarily skilled in the art, a flip is the simplest type of correlated transition in contacting pairs wherein a substitution in one site is compensated by an opposite substitution in the other site. Thus, on the average, flipped matrix-elements represent higher probabilities than invariant matrix-elements, which, as stated, preferably represent low probabilities. In the representative example illustrated in FIGS. 1a-b, the average value of the “invariant” matrix-elements is 0.052±0.304 and the average value of the “flipped” matrix-elements is about five times larger (0.304±0.601).

In terms of percentiles, the contact log likelihood probabilities of invariant matrix-elements are preferably, but not obligatorily, as follows: the value of the tenth percentile is about −0.36, the value of the median is about 0.06 and the value of the ninetieth percentile is about 0.43. For the flipped matrix-elements, the contact log likelihood probabilities are preferably but not obligatorily as follows: the value of the tenth percentile is about −0.49, the value of the median is about 0.28 and the value of the ninetieth percentile is about 1.03.

Nevertheless, there are some situations in which particular flipped pairs are assigned with lower probabilities. Representative examples of such flipped pairs comprise flipped pairs having a large aromatic side chain, such as, but not limited to, Trp and Tyr. In particular, the pairing of Gln or Thr, with both Trp and Tyr (Gln-Trp, Gln-Tyr, Thr-Trp and Thr-Tyr), and the pairing of Gly, Val, Cys, Ile, Asn, Pro or Asp with either Trp or Tyr (Gly-Trp, Val-Trp, Ile-Trp, Cys-Tyr, Pro-Tyr, Asn-Tyr and Asp-Tyr) is associated with low contact probabilities probably due to steric hendrence. Typical log likelihood probabilities for matrix-element representing such flipped pairs are from about −1.25 to about −0.3.

Representative examples of preferred log odd values of flipped matrix-elements include, without limitation, about −0.32 for a flip of the pair Thr-Trp, about −0.57 for a flip of the pair Gln-Tyr, about −0.59 for a flip of the pair Gln-Trp, about −0.61 for a flip of the pair Thr-Tyr, about −0.63 for a flip of the pair Gly-Trp, about −1.02 for a flip of the pair Val-Trp or the pair Cys-Tyr, about −1.09 for a flip of the pair Pro-Tyr, about −1.16 for a flip of the pair Asp-Tyr, about −1.21 for a flip of the pair Asn-Tyr, and about −1.24 for a flip of the pair Ile-Trp.

A preferred method for calculating all (invariant and transitional) matrix-elements of the pair-to-pair substitution matrix of various exemplary embodiments of the present invention is detailed in the Examples section that follows.

The pair-to-pair substitution matrix of the present embodiments can be used in many ways. As demonstrated in the Examples section that follows, it was found by the Inventors of the present intention that the matrix is particularly useful for the prediction of contacts in the protein hydrophobic core, which are known to be informative for protein structure modeling.

Yet, it is to be understood that it is not intended to imply that the matrix of the present embodiments is limited in its use to the prediction of putative contacts within hydrophobic cores of proteins. As further explained hereinafter, the pair-to-pair substitution matrix can be used for predicting inter-protein contacts, multimeric protein contacts and three-dimensional structures of the entire protein or any portion thereof, including, without limitation, the hydrophobic core and the solvent accessible part of the protein in question.

In the latter cases, the accessibility of the protein can be predicted from the available sequence data, as will be shown below. In other cases the protein structure can be known but not the contacts of it residues with another protein or molecule. Thus, predicted or known protein structure data can be used together with the pair-to-pair substitution matrix of the present embodiments, and the matrix can also be used to predict, verify or improve the prediction of protein structures.

As used herein the term “contact” refers to a covalent (non-peptide bond) or non-covalent interactions between at least two non adjacent amino acids.

Following is a description of various applications for which the pair-to-pair substitution matrix can be useful. Each of the following applications can be in a form of a method, which comprises one or more method steps to be executed, or in the form of an apparatus having one or more components capable of performing various method steps.

The methods of the present embodiments can be embodied in many forms. For example, the methods can be embodied in on a tangible medium such as a computer for performing the method steps. The methods can be embodied on a computer readable medium, comprising computer readable instructions for carrying out the method steps. The methods can also be embodied in electronic device having digital computer capabilities arranged to run the computer program on the tangible medium or execute the instruction on a computer readable medium.

Apparatus for implementing the methods of the present embodiments can commonly be distributed to users on a distribution medium such as an electronically readable data storage medium in a form of computer programs. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of the present embodiments. All these operations are well-known to those skilled in the art of computer systems.

In various exemplary embodiments of the invention the matrix can be used for predicting contacting sites in a target protein having a known primary sequence and an unknown three-dimensional structure.

As used herein the term “target protein” refers to a natural or synthetic (e.g., recombinant) polypeptide of interest or portions thereof (e.g., peptide) which is of sufficient length to form contacts (e.g., at least 20 amino acids in length).

The amino acid sequence of the target protein may be obtained from publicly available databases (e.g., http://www.ncbi.nlm.nih.gov) or determined experimentally be sequencing.

This can be done, for example, by providing a multiple sequence alignment containing the sequence of the target protein.

As used herein “sequence alignment” refers to an arrangement of two or more amino acid primary sequences (including that of the target protein), highlighting their similarity. The sequences may be padded with gaps so that wherever possible, columns contain identical or similar characters from the sequences involved. The sequence alignment of the present invention may comprise homologous amino acid sequences and/or orthologous amino acid sequences or a combination thereof. The method is applicable in any level of conservation. Nevertheless, too high conservations values may be non-informative to detect correlation between sites, while too low conservations values may lead to erroneous contact prediction. Thus, according to a preferred embodiment of the present invention the sequence alignments has intermediate level of conservation, say from a sequence conservation value of about 30% to a sequence conservation value of about 60%.

As used herein “multiple sequence alignment” refers to a primary sequence alignment having at least three rows of primary sequences. Preferably, but not obligatorily a multiple sequence alignment comprises 10 or more rows of primary sequences.

It will be appreciated that when a protein of a known three dimensional structure is included in the alignment, a sequence alignment which comprises only two rows (i.e., target protein and protein of known structure) may be used.

It was found be the Inventors of the present invention that better results are obtained when the number of columns (corresponding to the overall number of amino acids not including gaps in each sequence), L, in a sequence alignment or a multiple sequence alignment is relatively short, preferably from about 40 to about 80, e.g., about 60 amino acids. In columns with gaps the procedure is preferably executed based on sequences with no gaps. Columns containing too many gaps (e.g., more than about 50% gaps) are preferably not included in the procedure.

Algorithms for generating sequence alignment are well known in the art (see. e.g., Pfam, available from Bateman et al., “The Pfam protein families database,” Nucleic Acids Res 2004; 32:D138-D141; HSSP, available from Dodge et al., “The HSSP database of protein structure-sequence alignments and family profiles,” Nucleic Acids Res 1998; 26(1):313-315; Nomad, available from http://www.expasy.org/tools/, etc.)

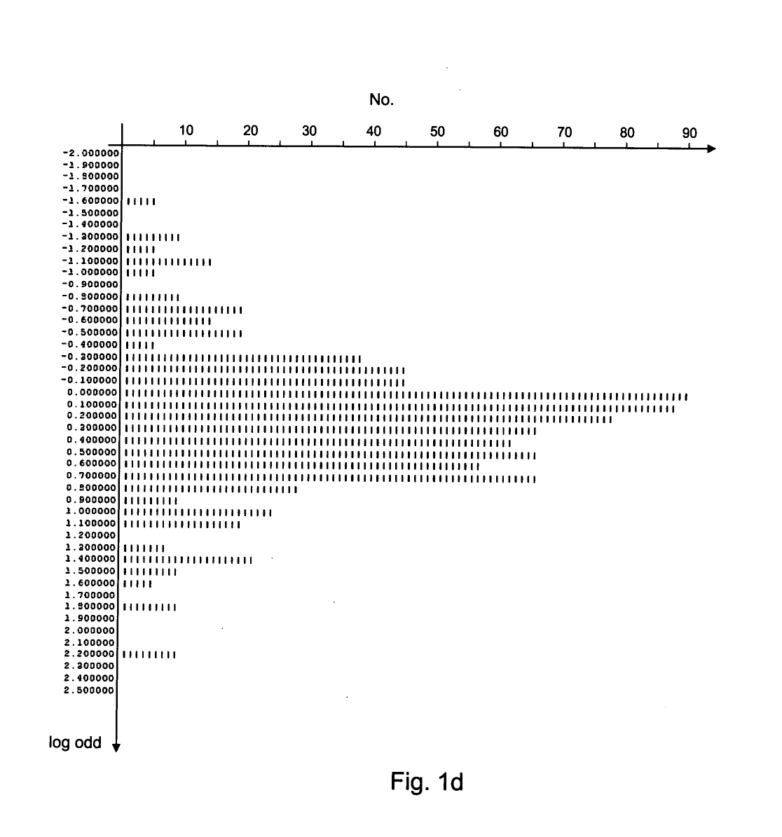

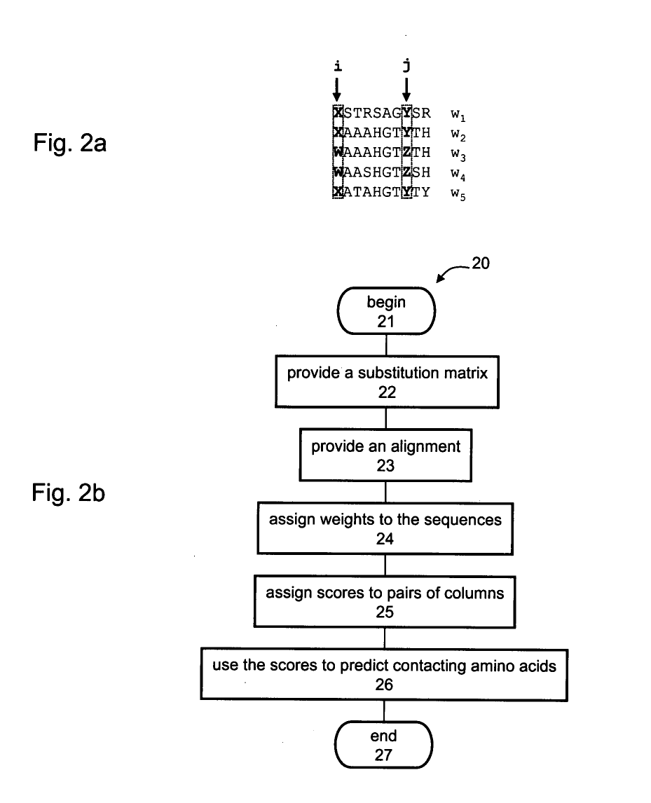

Once the multiple sequence alignment is provided, the matrix-elements of P2PMAT can be utilized for predicting the contacting amino acids of the target protein. The procedure is illustrated in FIGS. 2a-b, where FIG. 2a illustrates a multiple sequence alignment, and FIG. 2b is a flowchart diagram of a method 20 for predicting putative contacting sites in a target protein, according to various exemplary embodiments of the present invention. For simplicity of presentation, the alignment in FIG. 2a comprises five rows and ten columns.

Method 20 begins at step 21 and continues to steps 22 and 23 in which a pair-to-pair substitution matrix (e.g., P2PMAT) and an alignment are provided. Optionally, the method proceeds to step 24 in which each sequence in the alignment is associated with a weight wₛ, s=1, 2, . . . , Nₛ, where Nₛ is the number of sequences in the alignment (Nₛ=5 in the present example). The weights can be calculated using any weighting procedure known in the art, including, without limitation, tree structure sequence weighting, position-based sequence weighting, maximum discrimination sequence weighting and the like (to this end see, e.g., Henikoff S and Henikoff J. “Position-based sequence weights”, J Mol Biol 1994; 253:574-578, the contents of which are hereby incorporated by reference).

The method preferably continues to step 25 in which scores are assigned to different pairs of columns in the alignment. Each score equals or corresponds to a contact probability for the respective pair. More specifically, the score for the pair (i,j), which consists the ith column and the jth column of the alignment, equals or corresponds to the probability that the amino acid in position i of sequence s in the alignment contacts the amino acid in position j of sequence s.

The scores can be assigned to all the pairs in the alignment, or to a subgroup of all the pairs. For example, referring to the simplified example of FIG. 2a (a 10 columns alignment), the scores can be assigned to all 45 possible pairs, or only to pairs which are sufficiently spaced apart. Typically, nearest neighbor columns or next-to-nearest neighbor columns do not contribute to the contact information of the target protein. Therefore, the scores can be calculated only for pairs of columns separated by at least d columns, where d is typically 2 or 3. Additionally, as the multiple sequence alignment can be gapped, the scores can be calculated only for columns on the alignment which have no more then a certain fraction, g, of gaps therein. A typical value for the gap fraction threshold, g, is about 0.4. Alternatively, scores of close pairs or pairs with gaps can be eliminated in a supplementary calculation as further detailed hereinunder.

The procedure for calculating the scores depends on the way the matrix-elements of P2PMAT were constructed. In the preferred embodiment in which each sequence s in the alignment is assigned with weight wₛ, the weights are preferably used for calculating the scores, as further detailed hereinbelow. Thus, the procedure for calculating the scores may also depend on the method used for weighting the alignment. The simplest way to calculate the pair-score of the ith and jth columns (see the emphasized columns in FIG. 2a) is by multiplying the weight of each sequence by the matrix-element which corresponds to the ith and jth columns and summing over all the sequences:

$${score}_{ij} = {\sum }_{{s , t}_{s < t}} {w}_{s} {w}_{t} M [ {s}_{i} {s}_{j} ] [ {t}_{i} {t}_{j} ] \qquad ( EQ . 1 )$$

where M[sᵢsⱼ][tᵢtⱼ] is the P2PMAT matrix-element according to the identity of the amino acids in columns i and j in sequences s and t. Other scoring procedures are not excluded from the scope of the present invention. For example, scoreᵢⱼ can be calculated using some function of the weights and/or some function of the matrix-elements.

The method continues to step 26 in which the scores or the corresponding contact probabilities are used to predict the contacting amino acids. For example, the contact probabilities can be subjected to a thresholding procedure which outputs all the pairs with are likely to be in contact (for example, all pairs with sufficiently high scores).

Alternatively, a graph theory can be employed to extract the pairs having the highest contact probabilities. Thus, a graph G(N, E) can be constructed in which the nodes correspond to amino acids (columns in the alignment), and the edges correspond to the contacting amino acids (with sufficiently high contact probabilities).

Once the graph is constructed, it can be analyzed to find highly connected regions over the graph. Preferably, the analysis of the graph is also directed for searching edges that are near other edges in the primary protein sequence. Specifically, the edge between positions x and y and the edge between positions u and v are declared as near each other in the primary sequence if (a) the distances on the primary sequence between x and v, and between y and u are less than D, or (b) the distances on the primary sequence between x and u, and between y and v are less than D. With D typically being a small number such as 3-5 residues. According to a preferred embodiment of the present invention the edges in the highly connected regions are identified as the pairs having the highest probabilities to be in contact. This embodiment is based on the observations that actual contacts in proteins tend to cluster and work together by interconnecting several residues between themselves, and that connected sequence regions typically have several contacts therebetween.

Prior to the search over the graph, a reduction procedure can be employed so as to eliminate edges which are not likely to contribute to the prediction process. For example, edges corresponding to close columns and/or gapped columns can be eliminated from the graph. To establish an informative topology for the graph, edges with low weights can also be eliminated from the graph, using a standard thresholding procedure. Since successful prediction can be obtained only with a relatively small fraction (about 26%) of the correct contacts, the thresholding procedure can be selected to eliminate the maximal number of low-weight edges which does not significantly affect the quality of the prediction due to loss of information. Since the contacts within the core of the protein are most useful to predict its fold, and intra-protein contact prediction for positions on the protein surface is complicated by the possibility of such positions might be involved in inter-protein contacts, elimination of positions which are likely to be on the protein surface can also be useful. The solvent accessibility of a protein position corresponds to the placement of protein positions on its surface or core and can be accurately predicted from a multiple alignment of the protein family, for example using the method of Adamczak et al., “Accurate prediction of solvent accessibility using neural networks-based regression,” Proteins, 2004, 56(4):753-67, the contents of which are hereby incorporated by reference. Representative examples of thresholding procedure suitable for the present embodiments include, without limitation, surface accessibility, a minimal raw score, a Z-score or a percentile score. The thresholding procedure can also be adapted according to the number of columns in the alignment.

Analysis of the graph is expected to modify the scores of its edges, generating new probabilities for contact between nodes. This procedure is optionally and preferably iterated by repeating the analysis of the graph with the new edge scores from the previous analysis. In each iteration step, the analysis parameters can be the same as in a previous iteration step, or they can be modifies, as desired. The number of iterations can be a predetermined constant number, which may depend on the characteristics of the analyzed graph and multiple sequence alignment (e.g., the number of alignment columns, the number of sequences in the alignment, the alignment conservation, the number of edges in the graph, the scores of the graph edges, etc.). Alternatively, the number of iterations can depend on the convergence of the analysis results. Preferably, the number of iterations can be set based upon a combination of the above techniques. Thus, according to the presently preferred embodiment of the invention the graph analysis is iterated until a predetermined criterion or a set of criteria are met. For example, the graph analysis can be iterated until convergence is achieved or until the number of iterations exceeds a predetermined parameter.

The graph can be analyzed using any graph analysis technique known in the art, including, without limitation, minimal spanning tree method, Markov clustering, mutual clustering coefficient method and the like. Graph analysis methods suitable for the present embodiments are found in many textbooks, articles, patents and patent applications (to this end see, e.g., U.S. Patent Application No. 20030014408, and Goldberg DS and Roth F. “Assessing experimentally derived interactions in a small world,” Proceeding of the National Academy of Science U.S.A. 2003, 100(8):4372-6, the contents of which are hereby incorporated by reference). One of ordinary skill in the art would know how to implement such algorithms for the purpose of locating highly connected regions on the graph and/or edges that are near other edges in the primary protein sequence. A preferred graph analysis procedure is detailed in the Examples section that follows.

Method 10 ends at step 27.

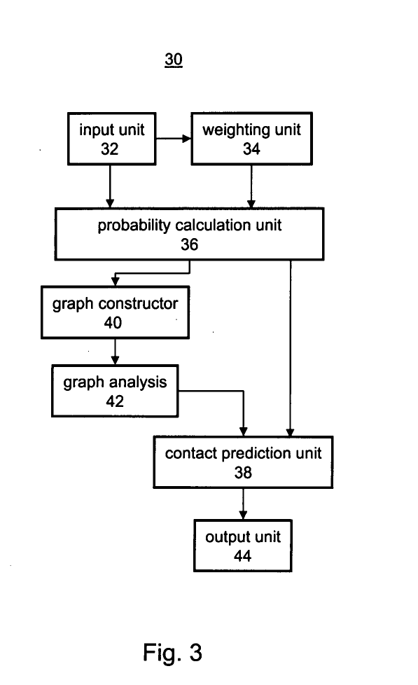

Reference is now made to FIG. 3 which is a simplified illustration of an apparatus 30 for predicting contacting amino acids, according to various exemplary embodiments of the present invention. Apparatus 30 can be used for executing one or more of the method steps of method 10. Apparatus 30 comprises an input unit 32 for inputting a multiple sequence alignment which contains the primary sequence of the target protein or a portion thereof. In various exemplary embodiments of the invention apparatus 30 further comprises a weighting unit 34, assigning weights wₛ to the sequences in the alignment, as further detailed hereinabove. Apparatus 30 further comprises a contact probability calculation unit 36 which calculates contact probabilities to different column pairs in the alignment. Unit 36 preferably assigns scores scoreᵢⱼ in accordance with Equation 1, or via any other scoring procedure as further detailed hereinabove.

A contact prediction unit 38 uses the contact probabilities for predicting the contacting amino acids in the target protein. Unit 38 can employ the aforementioned thresholding procedure which outputs all the pairs with are likely to be in contact, or it can employ graph theory for predicting the contacting amino acids. Thus, in various exemplary embodiments of the invention apparatus 30 comprises a graph constructor 40 associated with a graph analysis functionality 42, for constructing and analyzing the graph as further detailed hereinabove and in the Examples section that follows. Apparatus 30 may further comprise an output unit 44, e.g., for issuing a report or displaying the predicted contacts in a graphical form.

The fold information embodied in the entries of the pair-to-pair substitution matrix of the present embodiment can be utilized for predicting the three-dimensional structure of a target protein or a portion thereof. Once the contacting amino acids of the target protein are detected (e.g., by executing selected steps of method 10), they can be used for predicting three-dimensional structures. Thus, depending on the separation between the contacting residues on the primary sequence, secondary or tertiary three-dimensional information can be predicted.

For example, suppose that for a particular protein it is predicted that amino acids x and y, respectively located at positions i and j (j>i) of the primary sequence, are in contact. Then, if the separation between positions i and j is between, say 2 and 10, the peptide defined from position i+1 to position j−1, may form a secondary structure (e.g., a helix or a strand). If on the other hand, the separation between positions i and j is large (say, above 10) the contact between x and y may correspond to a tertiary structure.

P2PMAT can be utilized in ab initio as well as knowledge based three-dimensional structure prediction techniques. For ab initio prediction techniques, P2PMAT can be used for prediction residue contacts solely from the primary sequence of the target protein. For knowledge based prediction techniques (e.g., threading or fold recognition) P2PMAT can be used for prediction residue contacts of the target protein based on a known three-dimensional structure of a template protein.

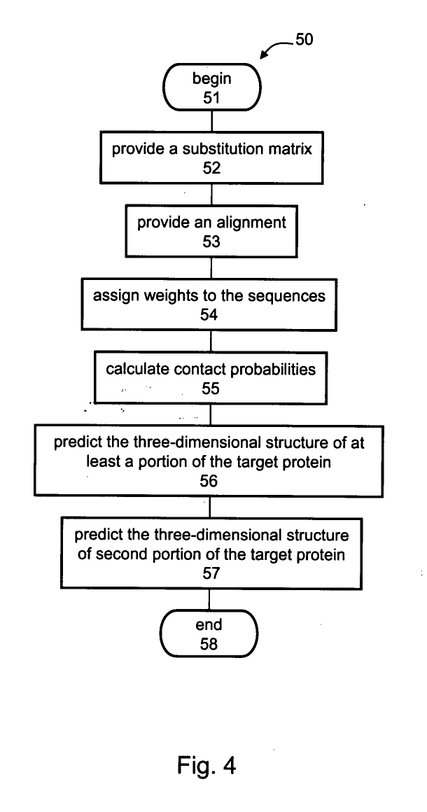

Reference is now made to FIG. 4 which is a flowchart diagram of a method 50 suitable for predicting at least a partial three-dimensional structure of a target protein.

The method begins at step 51 and continues to step 52 in which a suitable substitution matrix, such as P2PMAT is provided. Method 50 continues to step 53 in which a sequence alignment which comprises at least a portion of the primary sequence of the target protein is provided. The sequence alignment can also be a multiple sequence alignment. Multiple sequence alignments are preferred in the embodiments in which P2PMAT is utilized in ab initio prediction techniques. For knowledge based prediction techniques, although multiple sequence alignment is not excluded, it is sufficient to provide a sequence alignment with two sequences which are preferably the primary sequences of the target and template proteins.

In the embodiments in which the alignment is a multiple sequence alignment, method 50, optionally and preferably, continues to step 54 in which each sequence in the multiple alignment is associated with weight as further detailed hereinabove. The method continues to step 55 in which the substitution matrix is utilized for calculating contact probabilities.

The contact probabilities can be calculated in more than one way. In the embodiment in which a multiple sequence alignment is used, a scoring procedure can be employed (see, e.g., Equation 1) to assign scores to pairs of columns in the alignment, from which the contact probabilities can be obtained as further detailed hereinabove and in the Examples section that follows.

In the embodiments in which the sequence alignment comprises two sequences (a target sequence and a template sequence), the contact probabilities are obtained from the known three-dimensional structure of the template protein. Specifically, according to the presently preferred embodiment of the invention the substitution matrix is utilized for calculating probabilities for substituting contacting pairs of the template sequence with respectively aligned pairs of the target sequence. For example, suppose that from the three-dimensional structure of the template protein it is known that amino acid x contacts amino acid y. Suppose further that amino acids x and y of the template protein are respectively aligned with amino acids u and v of the target protein (that is the template and target are aligned such that x and u have the same position and y and v have the same position). The corresponding matrix-element of the substitution matrix (M_{[xy][uv]} in the present example) is then utilized to determine the likelihood of the transition from the pair (x, y) to the pair (u, v). This likelihood can be interpreted as the contact probability of amino acid u with amino acid v.

Method 50 continues to step 56 in which the contact probabilities (or transition likelihoods) are used for predicting a partial or the full three-dimensional structure of the target protein. When only a partial three-dimensional structure is predicted, it is preferably the three-dimensional structure of the hydrophobic core of the target protein. The hydrophobic core can be calculated analytically, for example, using the Voronoi procedure, described in McConkey et al., “Quantification of protein surfaces, volumes and atom-atom contacts using a constrained Voronoi procedure,” Bioinformatics 2002; 18:1365-1373, the contents of which are hereby incorporated by reference.

In the in ab initio case, where there is no additional fold information, the three-dimensional structure of the target protein (or the hydrophobic core thereof) can be predicted by judicious interpretation of the separation between the contacting sites, as explained above. In the knowledge based case, the additional fold information extracted from the template protein can be utilized to predict the shapes which are formed between the contacting sites.

In both cases, graph theory can be employed to further analyze the obtained contact-probabilities prior to the prediction or determination of the three-dimensional structure, for the purpose of, e.g., reducing or eliminating “false positive” events. Thus, a graph can be constructed and analyzed so as to find highly connected regions over the graph and/or edges that are near other edges in the primary protein sequence, as explained hereinabove and in the Examples section that follows.

The Inventors of the present invention have unexpectedly uncovered that the use of the pair-to-pair substitution matrix of the present embodiments can be synergistically combined with a supplementary algorithm, where the substitution matrix is utilized to predict the three-dimensional structure of the hydrophobic core and the supplementary algorithm is utilized to predict the three-dimensional structure of the solvent accessible portions of the target protein.

Thus, in various exemplary embodiments of the invention method 50 continues to step 57 in which a supplementary algorithm is applied for predicting the three-dimensional structure of at least a second portion of the target protein, where the second portion is preferably other than the hydrophobic core. The combination between the results obtained using the pair-to-pair substitution matrix and the results obtained using the supplementary algorithm can be performed in any way known in the art.

In one exemplary embodiment, all information regarding the hydrophobic core of the target protein is extracted solely from the pair-to-pair substitution matrix as described above, and all information regarding the solvent accessible part of the target protein is extracted solely from the supplementary algorithm. In this embodiment, a low accessibility threshold is preferably applied to define defined the protein core. This can be done by classifying each amino acid of the primary sequence to subsets of amino acids. The classification can be done according to the relative affinity of the respective amino acid for water. Thus, the core of the protein generally includes hydrophobic amino acids, the surface of the protein generally includes hydrophilic amino acids and the boundary between the core and the surface generally includes amino acids of less pronounced hydrophobic/hydrophilic properties or a mixture of amino acids of both types. Methods for applying low accessibility thresholds are known in the art and are found, for example, in Adamczak et al., supra.

In another embodiment, a weighting procedure is employed to combine the results of the two techniques, where the weights depend on the distance from the hydrophobic core. Specifically, near the hydrophobic core the weights are higher for information obtained using the pair-to-pair substitution matrix, and far from the core the weights are higher for information obtained using the supplementary algorithm.

The supplementary algorithm can be any known algorithm suitable for predicting three-dimensional structures of protein in a knowledge based or ab initio manner. Representative examples include, without limitation, residue-residue contacts prediction algorithm, correlated mutation analysis, Monte Carlo folding simulations and the like. The supplementary algorithm can also utilize a supplementary substitution matrix, such as, but not limited to, a binary matrix, a blocks substitution matrix and a biophysical complementarity matrix.

It is expected that during the life of this patent many relevant three-dimensional structure prediction methods will be developed and the scope of the term supplementary algorithm in this context is intended to include all such new technologies a priori.

Supplementary algorithms which are suitable for the present embodiments are found in the literature and in many patents and patent applications, see, e.g., U.S. Pat. Nos. 6,377,893, 6,512,981, 6,859,736; U.S. Patent Application Nos. 20050026217, 20020150906, 20020111781; Ortiz et al., “Native-like topology assembly of small proteins using predicted restraints to Monte Carlo folding simulations,” Proceedings of the National Academy of Science 1998, 95:1020-1025; Zhang et al., “TOUCHSTONE II: a new approach to ab initio protein structure prediction,” Biophys J 2003, 85(2):1145-1164, Shindyalov et al., “Can three-dimensional contacts in protein structures be predicted by analysis of correlated mutations?” Prot Eng 1994, 7:349-358; Gobel et al. “Correlated mutations and residue contacts in proteins,” Proteins 1994, 18:309-317; Olemea et al. “Effective use of sequence correlation and conservation in fold recognition,” J Mol Biol 1999, 295:1221-1239; and Gromiha et al., “Inter-residue interactions in protein folding and stability,” Prog Biophys Mol Biol 2004, 86(2):235-277, the contents of which are hereby incorporated by reference.

Method 50 ends at step 58.

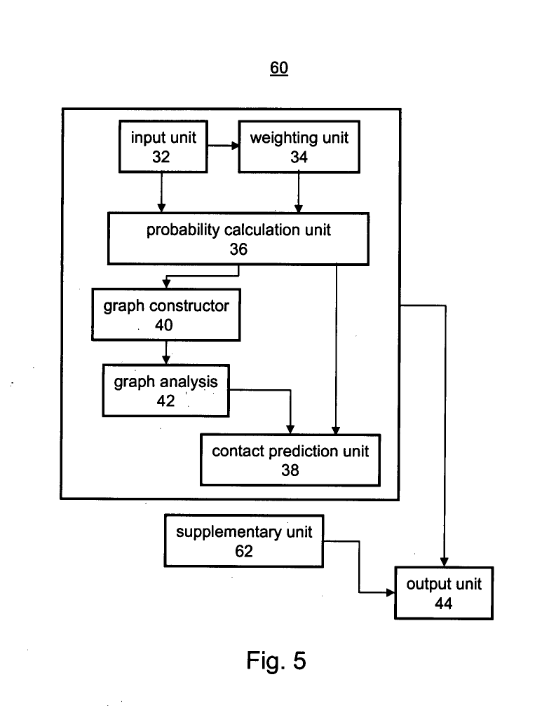

Reference is now made to FIG. 5 which is a schematic illustration of an apparatus 60 for predicting at least a partial three-dimensional structure of a target protein, according to various exemplary embodiments of the present invention.

Apparatus 60 can be used for executing one or more of the method steps of method 50. Apparatus 60 can comprise several or all of the components of apparatus 30 above including, without limitation, input unit 32, weighting unit 34, contact probability calculation unit 36, contact prediction unit 38, graph constructor 40, graph analysis functionality 42 and output unit 44. The principle and operations of these components when embodied in apparatus 60 are generally similar, mutatis mutandis, to those described above with reference to FIG. 3. For example, when contact probability calculation unit 36, it is preferably configured also to predict three-dimensional structures as further detailed hereinabove.

In various exemplary embodiments of the invention apparatus 60 further comprises a supplementary unit 62 which applies the appropriate supplementary algorithm for predicting the three-dimensional structure of the other portion of the target protein, as further detailed hereinabove.

Apparatus 60 or method 50 can be used either as a predicting tool per se, or as a tool for assessing the quality of three-dimensional models for a given protein sequence. For example, apparatus 60 or selected steps of method 50 can be used for filtering or ranking decoy structures of a given protein having a known sequence. In this embodiment, a score is assigned to each decoy structure in a plurality of decoy structures and the decoy structures are then ranked by their scores. A preferred procedure for scoring a set of decoy three-dimensional structures is provided in the Examples section that follows (see Equation 7). The decoy structure having the highest score can then be selected as a structure likely to be closest to the native three-dimensional structure of the protein.

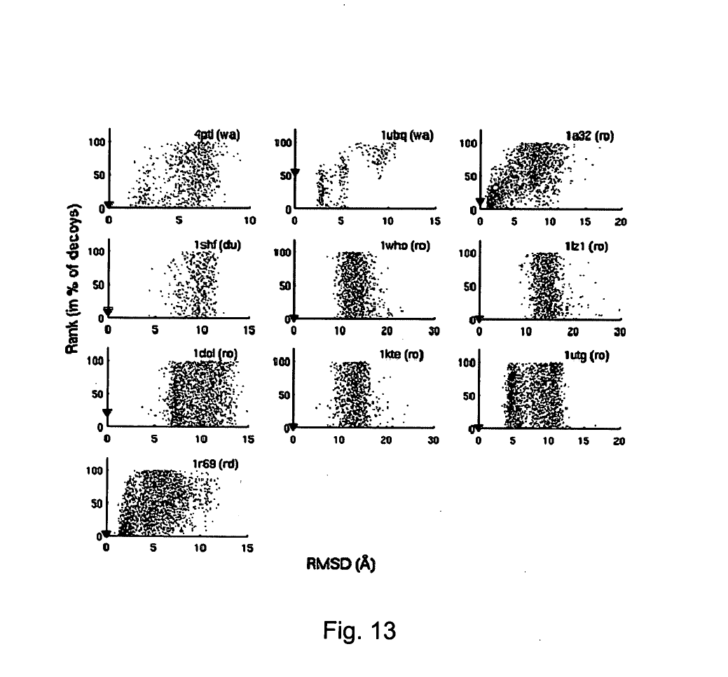

Alternatively, several decoy structures (e.g., the decoy structures for which having the top 10% scores were assigned) can be selected as candidates for being the native structure of the protein. Further, a supplementary algorithm can be employed for selecting the native structure from the candidate structures. As demonstrated in the Examples section that follows (see Example 2 and FIG. 13), the method of the present embodiment is capable of predicting the native structure of a protein with a high level of confidence.

An additional application for which the pair-to-pair substitution matrix of the present embodiment can be utilized is in the area of protein design. In these embodiments, a protein molecule can be designed in accordance with a desired three-dimensional structure. Thus, in a sense, protein design is the reverse of the above three-dimensional structure prediction embodiments. A tertiary structure of the protein is the input, and a primary sequence, which is predicted to fold to the tertiary structure, is the output.

The present embodiments also allow the prediction of secondary protein structures (independently or on top of the above described three-dimensional structures). In these embodiments, the matrix-elements of the pair-to-pair substitution matrix preferably represent pair-to-pair preferences in short distances (e.g., less than 10 amino acids) according to secondary elements (e.g., alpha helix, beta pleated sheet and collagen helix). These preferences can then be applied for prediction of two-dimensional structures, in a similar manner as described above for predicting three-dimensional structures. It will be appreciated that the dividing line between secondary and tertiary structure may be arbitrarily set.

The present embodiments are suitable both for designing the protein molecule from scratch (de novo protein design), or for modifying an existing template protein molecule such as to transform its structure to the desired three-dimensional structure. The output can be done either an entire protein three-dimensional structure or a portion thereof. For example, the present embodiments can be used for designing a backbone, one or more side chains, a hydrophobic core portion, a solvent accessible portion or any other subsets of the three-dimensional structure of the protein, including combination of several subsets.

The present embodiments are particularly useful as a computational drug design methodology. Since the three-dimensional structure of the protein is related to its biological function, the drug designers can design and screen potential new drugs via computational methods by first specifying the three-dimensional structure which is likely to achieve the desired biological effect and then using the present embodiments for predicting the primary sequence which fold to the specified structure.

The present embodiments are also useful as a computational screening methodology, whereby each protein (or some subset of residues) of a library of known scaffold proteins or random peptides is screened for stability or other properties. As will be appreciated, by using computational methods to generate a threshold or cutoff to eliminate disfavored sequences, the percentage of useful variants in a given variant set size can increase, and the required experimental outlay is decreased.

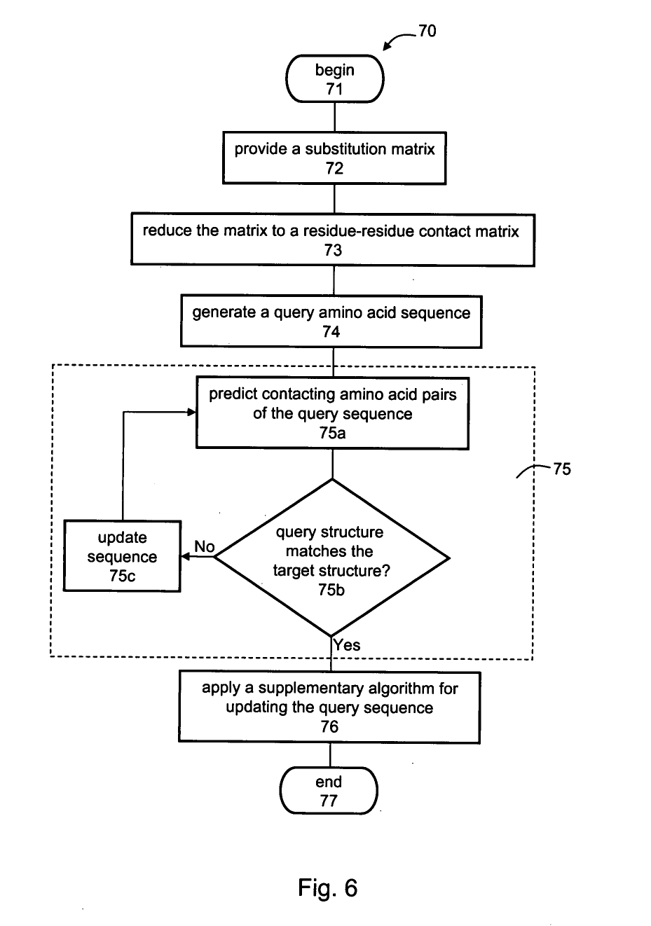

Reference is now made to FIG. 6 which is a flowchart diagram of a method 70 suitable for designing at least a portion of a protein having a target three-dimensional structure, according to various exemplary embodiments of the present invention. The target three-dimensional structure can be represented by an ordered set of coordinates over a system of coordinates in three dimensions. The structure is characterized by a plurality of contacting points, which represent contacts between two amino acids in the protein to be designed. Each contacting point can be a repetitive point in the ordered set or a point in the set which is sufficiently close (e.g., within a distance of 1 Angstrom or less) to another point in the set.

Method 70 begins at step 71 and continues to step 72 in which a suitable substitution matrix, such as P2PMAT is provided. Method 70 continues to step 73 in which the pair-to-pair substitution matrix is reduced to a residue-residue contact matrix.

As stated, P2PMAT includes N⁴ matrix-elements (for N types amino acids), arranged N² rows and N² columns, where each row (and column) represent one pairing between two amino acids. The residue-residue contact matrix includes N² matrix-elements arranged in N rows and N columns, where each row (and column) represents one amino acid. Each matrix-element of the residue-residue contact matrix represents a contact probability between the amino acid corresponding to the row and column of the matrix-element. For example, R_{xy} the matrix-element of row x and column y represents the probability that amino acid x contacts amino acid y.

The reduction of the pair-to-pair substitution matrix to a residue-residue contact matrix is a straightforward algebraic manipulation. As exemplified below, summarizing the elements scores of a specific pair (400 values) provides indication to the contact potential between the residues of that pair. For example, if the values are high on the average, it means that this pair is more likely to be substituted. In other words, the contact potential of the pair members is not favorable.

In one preferred embodiment, the reduction of the pair-to-pair substitution matrix to a residue-residue contact matrix can be done as follows. Each matrix-element R_{xy} of the residue-residue contact matrix can be calculated from one or more matrix-elements of the row (or column) of P2PMAT which corresponds to the respective two amino acids of R_{xy}. Specifically, R_{xy}=fᵤᵥ⊕ M_{[xy][uv]}, where fᵤᵥ⊕ represents a mathematical operation which contracts the indices u and v. A representative example for an index contraction operation is the average operation (fᵤᵥ⊕→(1/N²)Σᵤᵥ). Hence, in this embodiment, R_{xy}=ΣᵤᵥM_{[xy][uv]}/N². The mathematical operation fᵤᵥ⊕ can be employed on all the N² matrix-elements of row [xy], or, more preferably, a thresholding procedure can be utilized so as to exclude one or more matrix-elements from the operation. For example, matrix-element M_{[xy][xy]} satisfying M_{[xy][xy]}<t_{R} can be excluded from the operation, where t_{R} is a predetermined threshold, which is typically 0.1. Alternatively, specific matrix-elements (e.g., the “flipped” matrix-element M_{[xy][yx]}, the fully symmetric matrix-element M_{[xy][xy]}, etc.) can be excluded a priori from the operation, without thresholding.

It is appreciated, however, that there is more than one algebraic manipulation which can be employed in order to obtain residue-residue contact matrix. One of ordinary skills in the art, provided with the pair-to-pair substitution matrix of the present embodiments and the details described herein, would know how to adjust the algebraic manipulation for providing other types of residue-residue contact matrices.

Method 70 continues to step 74 in which a query amino acid sequence is generated. The query amino acid sequence can be generated by selecting a set of amino acids and arranging the set in a particular order, or it can be generated by replacing one or more amino acids in of an existing sequence of a template protein. The method continues to step 75 in which the residue-residue contact matrix is utilized for iteratively updating the query sequence, so as to ensure that the query sequence comprises contactable pairs which correspond to the contacting points characterizing the target three-dimensional structure. Typically, step 75 comprises three sub-steps shown in FIG. 6 as process steps 75a and 75c and decision step 75b.

Thus, at process step 75a the method utilizes the entries of the residue-reside contact matrix to predict the contacting amino acid pairs of the query sequence. The prediction of contacting amino acid pairs can be done by thresholding or by employing graph theory, as further detailed hereinabove and in the Examples section that follows. The fact that the matrix is a residue-residue matrix rather than a pair-to-pair substitution matrix should not confuse the skilled artisan because the procedures typically involve scalar operations performed on the individual matrix-elements (as opposed to matrix manipulations which are one- or two-form operations performed on matrices or blocks thereof).

From step 75a the method continues to decision step 75b in which the method predicts whether or not the three-dimensional structure to which the query sequence may fold matches, to a predetermined level of conformation, the target three-dimensional structure. This prediction can be done by comparing the locations of the contacting points along the target structure with the positions of the contacting amino acid pairs along the query sequence. If the structures do not match, the method proceeds to process step 75c in which the query sequence is updated by replacing one or more of the amino acid thereof. From and step 75c the method loops back to step 75a. The method continues to iterate between steps 75a, 75b and 75c until the level of conformation between the target structure and the query sequence structure reaches the predetermined conformation level (say, at least 25% conformation). Once the predetermined conformation level is reached, the method exits step 75.

One or more portions of the structures can be excluded from the determination of the conformation level. For example, when it is desired to modify a specific portion of a template protein, only the three-dimensional structure of the specific portion and only the query sequence which corresponds to the specific portion preferably participate in the process. Similarly, when it is desired to design only a specific portion of a protein molecule (e.g., its hydrophobic core), only the three-dimensional structure of the core and only the query sequence which corresponds to the core preferably participate in the process.

In various exemplary embodiments of the invention method 70 continues from step 75 to step 76 in which a supplementary algorithm is applied for updating the query sequence to conform to another portion (e.g., surface) of the target structure. The supplementary algorithm can be applied in an iterative manner as described above. The supplementary algorithm can be any of the above algorithms for predicting three-dimensional structures of proteins. Alternatively, the supplementary algorithm can be a protein design algorithm, such as the algorithms disclosed in U.S. Pat. Nos. 6,188,965, 6,269,312, 6,403,312, 6,708,120, 6,792,356, 6,801,861, 6,804,611 and 6,950,754; and U.S. Patent Application Nos. 20010032052, 20010039480, 20020004706, 20020048772, 20020052004, 20020090648, 20020106694, 20020119492, 20030022285, 20030049654, 20030049680, 20030130827, 20040043429, 20040043430, 20040229290, 20050038610 and 20060019316.

The method ends at step 77.

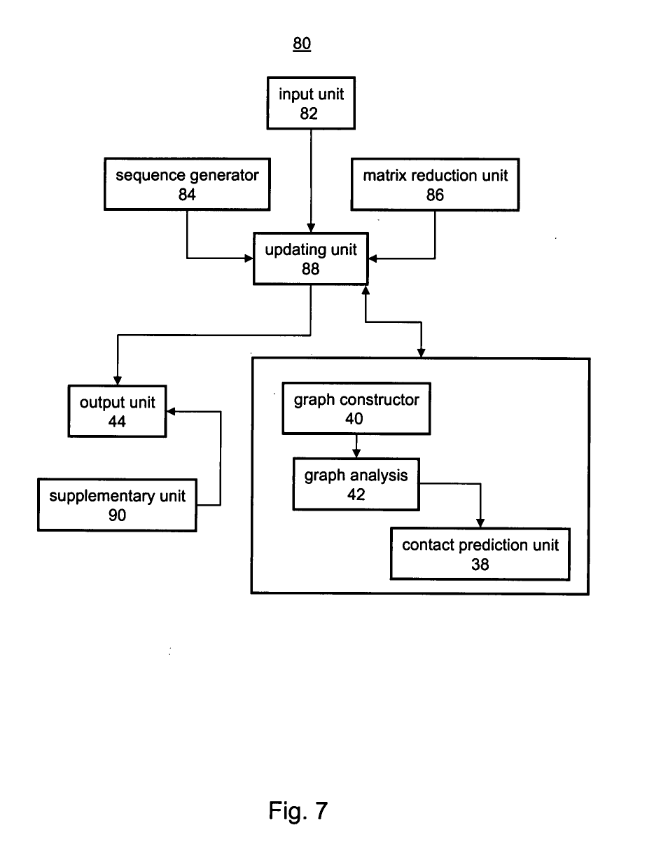

Reference is now made to FIG. 7 which is a schematic illustration of an apparatus 80 for designing at least a portion of a protein having a target three-dimensional structure, according to various exemplary embodiments of the present invention. Apparatus 80 can be used for executing one or more of the method steps of method 70.

Apparatus 80 preferably comprises an input unit 82, for inputting the target three-dimensional structure and an amino acid sequence generator 84 which generates the query sequence. Generator 84 can generate an entire sequence or a portion of a sequence as desired. Generator 84 can use any sequence generation routine such as, but not limited to, a routine which randomly generates sequences of amino acids or a routine that uses some known information for generating the query sequence. For example, when it is desired to use specific types of amino acids (e.g., hydrophobic amino acids), generator 84 can give higher probabilities to the generation of sequences which include the specific types.

Apparatus 80 further comprises a matrix reduction unit 86 which reduces the substitution matrix to the residue-residue contact matrix as further detailed hereinabove, and a sequence updating unit 88, which is iteratively activated to update the query sequence until the level of conformation between the target structure and the query sequence structure reaches the predetermined conformation level.

In various exemplary embodiments of the invention apparatus 80 comprises contact prediction unit 38, graph constructor 40, graph analysis functionality 42 and/or output unit 44. The principle and operations of these components when embodied in apparatus 80 are generally similar, mutatis mutandis, to those described above with reference to FIGS. 3 and/or 5. For example, when contact probability calculation unit 36, it is preferably configured also to predict three-dimensional structures as further detailed hereinabove.

In various exemplary embodiments of the invention apparatus 80 further comprises a supplementary unit 90 which applies the appropriate supplementary algorithm for updating the query sequence to conform to another portion (e.g., surface) of the target structure, as further detailed hereinabove.

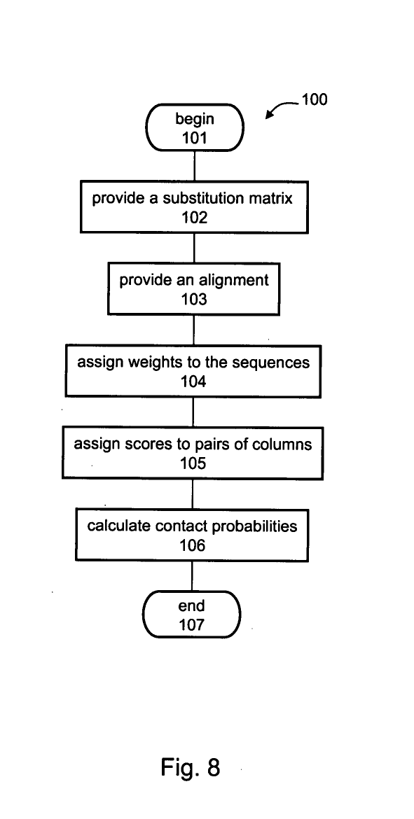

Reference is now made to FIG. 8 which is a flowchart diagram of a method 100 suitable for predicting interaction sites between two or more proteins of known primary sequence, according to various exemplary embodiments of the present invention. The proteins can form a multimeric protein via the interaction sites. Method 100 can predict interaction sites of two or more proteins of known or unknown three-dimensional structure. Thus besides primary sequence of the proteins, the information needed to be provided to method 100 can be at least of (i) sequence alignment of one or more proteins, (ii) three-dimensional structure of one or more proteins.

Method 100 inputs the information and utilizes the pair-to-pair substitution matrix to predict the interaction sites between the proteins as further detailed hereinbelow. Method 100 can be executed by apparatus 30, 60, 80 or any combination between their components.

Method 100 begins at step 101 and continues to step 102 in which a pair-to-pair substitution matrix (e.g., P2PMAT) is provided. Optionally, the method continues to step 103 in which one or more sequence alignments (such as, but not limited to, multiple sequence alignments), each containing the amino acid sequence of one protein, are provided.

In the embodiments in which multiple sequence alignment(s) are provided, method 100 preferably continues to step 104 in which each sequence in the alignment(s) is associated with a weight, as further detailed hereinabove. According to a preferred embodiment of the present invention the method can then continue to step 105 in which scores are assigned to different pairs of columns in the alignment. The method can then continue to step 106 in which contact probabilities are calculated to predict the contacting amino acids. The contact probabilities correspond to contacts between pairs of different proteins. For example, when there are two proteins, the probabilities correspond to contacts between pairs of the first amino acid sequence and pairs of the second amino acid sequence.

When the input to method 100 includes one or more multiple sequence alignments, the contact probabilities can be calculated according to the preferred embodiments of method 20 above. When the input to method 100 includes three-dimensional information of one or more proteins, the contact probabilities can be calculated by according to the preferred embodiments of method 50, where knowledge based contact probabilities are calculated.

Method 100 ends at step 107.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

### A Prototype Pair-to-Pair Substitution Matrix

Following is a description of prototype pair-to-pair substitution matrices, P2PMAT calculated in accordance with various exemplary embodiments of the present invention.

The multiple alignments for constructing these prototype pair-to-pair substitution matrices were obtained from the Blocks database [Henikoff J and Henikoff S., “Automated assembly of protein blocks for database searching,” Nucl Acids Res 1991; 19:6565-6572; and Henikoff J, Henikoff S and Pietrokovski S., “A non-redundant database of protein alignment blocks derived from multiple compilations,” Bioinformatics 1999; 15:471-479] versions 13 and 14. The Blocks database is publicly available (ftp://ftp.ncbi.nih.gov/repository/blocks/unix/old/blocks-13.0.dat.gz for version 13 and ftp://ftp.ncbi.nih.gov/repository/blocks/unix/old/blocks-14.0/ for version 14).

The Blocks database was used to extract all blocks with an available crystal structure from a PDB database obtained from Berman et al., “The Protein Data Bank,” Nucleic Acids Res 2000; 28(1):235-242, for at least one of the proteins in the block (a “representative structure” for this block). For blocks including several crystal structures, the structure with the best resolution was taken. Blocks represented only by NMR models were excluded. Each pair of columns within a block was classified as either contacting or not, according to the contact surface area analysis of the representative structure of the block.

One prototype pair-to-pair substitution matrix was derived from 3493 block multiple alignments of 828 protein families from the Blocks database, version 13, with 1035 representative structures. This prototype matrix is provided in file P2Pmat.txt in enclosed CD-ROM 1. Other pair-to-pair substitution matrices were derived from version 14 of the Blocks database, which is considerably larger. These matrices are provided in files P2Pmat14Inter.txt, P2Pmat14Intra.txt and P2Pmat14Burried.txt enclosed CD-ROM 1. The matrix in P2Pmat14Inter.txt was obtained considering contacts within blocks as well as between blocks from the same family, the matrix in P2Pmat14Intra.txt was obtained considering only contacts within the blocks, and the matrix in P2Pmat14Burried.txt was constructed considering only contacts within the core of the protein. The data used for constructing all the prototype pair-to-pair substitution matrices is provided in files Block13-data.txt (for the matrix in file P2Pmat.txt) and Block14-data.txt (for the matrices in files P2Pmat14Inter.txt, P2Pmat 14 Intra.txt and P2Pmat 14Burried.txt).

Following is a detailed description of the procedure used to construct the prototype pair-to-pair substitution matrix in file P2Pmat.txt. One of ordinary skills in the art, provided with the details described herein would know how to adjust the procedure for constructing other pair-to-pair substitution matrices (e.g., those provided in enclosed CD-ROM 1).

The prototype matrix P2PMAT comprises 160,000 ((20×20)×(20×20)) elements which approximate the probability of changes from any pair of amino acids (x,y) to another pair (u,v) in the same two columns of a multiple sequence alignment. Namely, when in one sequence residue x is found in position i and residue y in position j, while in another sequence of the same alignment residue u is found in position i and residue v in position j.

Each matrix element M_{[xy][uv]} for the transitions x [symbol] u and y [symbol] v was calculated based on two components. A first component was derived from pair-to-pair substitutions in positions of the multiple sequence alignment having a contact (according to the representative structure of the protein family). This component reflects a contact signal. The second component was based on pair-to-pair substitution of non-contacting sites, reflecting the background noise for the purpose of contact prediction.

The following equation was applied to derive M[xy][uv] with the score of pair-to-pair substitutions from amino acids x [symbol] u at one position and y [symbol] v at another position simultaneously:

$$M [ xy ] [ uv ] = ln \frac{{f}_{obs}^{con} [ xy ] [ uv ]}{{f}_{exp}^{con} [ xy ] [ uv ]} - ln \frac{{f}_{obs}^{nocon} [ xy ] [ uv ]}{{f}_{exp}^{nocon} [ xy ] [ uv ]} , \qquad ( EQ . 2 )$$

where f_{obs}^{con}[xy][uv], fₑₓₚ^{con}[xy][uv] are observed and expected frequencies for contacting pairs, respectively; and f_{obs}^{nocon}[xy][uv], fₑₓₚ^{nocon}[xy][uv] are observed and expected frequencies for non-contacting pairs, respectively. The observed frequencies f_{obs}^{con}[xy][uv] of the simultaneous substitutions x [symbol] u, y [symbol] v in two block columns, which have a direct contact, were calculated according to the following equation:

$${f}_{obs}^{con} [ xy ] [ uv ] = \frac{{n}_{obs}^{con} [ xy ] [ uv ]}{{\sum }_{abcd} {n}_{obs}^{con} [ ab ] [ cd ]} \qquad ( EQ . 3 )$$

where n_{obs}^{con}[xy][uv] is a weighted sum for the counts of all x [symbol] u, y [symbol] v simultaneous substitutions, calculated according to the following equation:

$${n}_{obs}^{con} [ xy ] [ uv ] = {\sum }_{b} {\sum }_{{s , t}_{s < t}}^{{N}_{b}} {\sum }_{{i , j}_{i < j}}^{{L}_{b}} {w}_{s} {w}_{t} δ ( \begin{matrix}{s}_{i} = x , {s}_{j} = y , \\ {t}_{i} = u , {t}_{j} = v\end{matrix} ) \qquad ( EQ . 4 )$$

where: b is an index running over all block entries with representative structures, N_{b} is the number of sequences, L_{b} is the alignment length of block b, wₛ, wₜ are position-specific weights [Henikoff and Henikoff 1994 supra] given to sequences s and t respectively in the block b, i and j are sequence positions, and sᵢ stands for the amino acid type found at position i in sequence s. The δ function in Equation 4 equals 1 if the four conditions in parentheses all hold and 0 otherwise.

The interpretation of the weighted sum n_{obs}^{con}[xy][uv] is as follows: for each pair of sequences s and t within the same block and each pair i and j of sequence positions having contact in the structure, the product of sequence weights wₛ and wₜ was added to the count of n_{obs}^{con}[sᵢsⱼ][tᵢtⱼ].

f_{obs}^{nocon}[xy][uv] was calculated in the same way but based on pairs of block positions with no direct contact.

The calculation of the expected frequencies was performed as follows:

$${f}_{exp}^{con} [ xy ] [ uv ] = \frac{{n}_{obs} [ x ] [ u ]}{{\sum }_{ab} {n}_{obs} [ a ] [ b ]} \cdot \frac{{n}_{obs} [ y ] [ v ]}{{\sum }_{ab} {n}_{obs} [ a ] [ b ]} \qquad ( EQ . 5 )$$

where

$${\sum }_{ab} {n}_{obs} [ a ] [ b ]$$

is a sum over all substitutions n_{obs}[a][b].

In Equation 5, n_{obs}[x][u] is a weighted count of substitutions x [symbol] u observed in each block column, calculated as follows:

$${n}_{obs} [ x ] [ u ] = {\sum }_{b} {\sum }_{{s , t}_{s < t}}^{{N}_{b}} {\sum }_{i}^{{L}_{b}} {w}_{s} {w}_{t} δ ( {s}_{i} = x , {t}_{i} = u ) \qquad ( EQ . 6 )$$

where the indices and functions in Equation 6 are defined above.

The interpretation of the weighted sum n_{obs}[x][u] is as follows: for each pair of sequences s and t within the same block, the multiplication of the sequence weights wₛ, wₜ was added to the count of n_{obs}[s₁] [tᵢ] for each position i.

fₑₓₚ^{nocon}[xy][uv] was calculated in an equivalent way to that of fₑₓₚ^{con}[xy][uv], with the difference that positions i and j separated by three amino acids or more along the sequence were used to derive the matrix. The sequence order of long-range interacting residues relative to each other does not influence their substitution rates, and pair substitutions were considered bi-directional.

The matrix-elements M[xy][uv], M[uv][xy], M[yx][vu] and M[vu][yx] were averaged and the result of the average was stored in each of these matrix-element so as to symmetrize P2PMAT.

The pairs of contacting residues were identified using contact surface areas between atoms. These areas were analytically calculated using the Voronoi procedure. To define contacts in representative structures for deriving the pair-to-pair substitution matrix, only contacts between side chain atoms (or C_{α} carbons for Gly) were considered, so as to derive more specific scores.

The contacting pairs data in the P2PMAT matrix is based on about 2.4·10⁸ counts of pair-pair substitutions. This gives a mean of 1500 counts for each matrix element, with 98.3% of the elements above a count of 50. The background data, for non-contacting pairs, is based on a much larger number of counts. Unlike most available methods aiming to detect correlated sites in proteins, P2PMAT was oriented to detect sites in direct contact, and was derived from protein structures including observed information about residue-residue contacts. The prototype matrix has relatively low scores for “invariance” matrix-element (0.052±0.304) compared to the generally higher scores for “flipped’ matrix-element (0.304±0.601), see also FIG. 1.

### Example 2

### Tests of the Prototype Pair-to-Pair Substitution Matrix

The prototype matrices of Example 1 were tested for detecting intra-protein contacts, using multiple sequence alignment of target proteins.

### Methods

The test set included families for which at least one of the family members is reported to be a monomer. The set included 94 monomers obtained from Ponstingl et al., “Discriminating between homodimeric and monomeric proteins in the crystalline state,” Proteins 2000; 41:47-57, the contents of which are hereby incorporated by reference. For each structure, the relevant multiple sequence alignment was obtained from the Pfam database [Bateman et al., supra], the contents of which are hereby incorporated by reference.

For most of the structures, seed alignments of the Pfam database were used. However, in four cases, where the seed alignments contained less than ten sequences, the full alignments from the Pfam database were used. Alignments with less than 15 sequences (27 cases) were excluded. Such alignments are not expected to contain enough information for correlated mutation analysis. Very short alignments of less that 25 residues (3 cases), and alignments with more than 50% gapped columns (5 cases) were also excluded. The remaining 59 families were used to test the prototype matrix.

The multiple sequence alignments were weighted according to the teachings of Henikoff and Henikoff (1994) supra. Each pair of columns of each multiple sequence alignment was scored according to Equation 1 above. Note that Equation 1 is analogues to Equation 4 used to derive the prototype matrix. According to a preferred embodiment of the present invention when other procedures are used to define the pair-to-pair substitution matrix, the scoring procedure is adjusted accordingly.

An expected accuracy for random predictions was calculated as the actual number of protein contacts divided by the number of potential contacts between all residues in the protein. This total number considers the different filters applied prior to the prediction. For example, if positions nearby on the sequence were not evaluated, this criterion was also taken for calculating the potential number of contacts.

For known protein structures, the solvent accessible surface was analytically calculated using the Voronoi procedure. The relative solvent accessibility is the solvent accessible surface divided by the theoretical maximum obtained from an extended GG×GG peptide. To predict solvent accessibility the SABLE program of Adamczak et al. (supra) was used. The predicted accessibility low pass filter was set to 0.15.

The method of the present embodiments was compared with two conventional methods. The method of Gobel et al. (supra), and the method of Singer et al. (supra). Contacts for the 59 protein families were predicted using the method of the present embodiments and the two conventional methods.

The performances of the method of the present embodiments was further compared to the PlotCorr program [Pazos et al., Olmea “A graphical interface for correlated mutations and other protein structure prediction methods,” Comput Appl Biosci 1997; 13:319-321; Olemea et al., “Improving contact predictions by the combination of correlated mutations and sources of sequence information,” Fold Des 1997;S2:S25-S32]. For the comparison with the PlotCorr program, HSSP alignments [Dodge et al., supra] of 55 families of the monomers were used.

For comparison between the methods only the set of contacts predicted by both methods was considered.

The pair-to-pair substitution matrix of the present embodiments was also used for evaluating protein fold stability based on structure contacts and the scores between the corresponding positions in a multiple sequence alignment. To this end, protein structures with proper decoy structure sets and multiple sequence alignments were examined. Decoy structure sets of different sources were organized and filtered according to several quality criteria as disclosed in Gilis D., “Protein decoy sets for evaluating energy functions”, J Bio Mol Struct Dyn 2004; 21:725-736. These decoy sets were further filtered according to the teachings of preferred embodiments of the present invention, as further described hereinbelow.

A decoy set was not tested if: (i) its target protein did not have a PFAM multiple sequence alignment, (ii) its PFAM seed alignment had less than 10 sequences, or (iii) the alignment contained too many gaps (more than 50%). The decoys used obtained from diverse sources (see the Results section, below). The amount of decoys in the sets ranged from 300 to 2000 structures.

PFAM alignments were obtained for each of the proteins of the decoy sets. The score S_{d} for each decoy d was calculated according to the following equation:

$${S}_{d} = {\sum }_{i , j} {C}_{ij}^{d} \cdot {score}_{i , j} , \qquad ( EQ . 7 )$$

where C^{d}ᵢⱼ equals 1 if position (i,j) have a contact surface area in decoy d structure, and are separated by at least 5 position in the sequence, and equal to 0 otherwise scoreᵢⱼ is the integrated P2PMAT score given according to various exemplary embodiments of the present invention to alignment positions ij (see Equation 1).

### Results

Multiple sequence alignments of protein monomers were analyzed using the prototype matrix of the present embodiments. The following results are presented by accuracy (selectivity), defined as the fraction of correct contacts from the L/k best contact predictions, where L is the alignment length and k is a constant.

Table 2 below summarizes the results. The accuracy of the L/10 best predicted contacts of all families is shown in column ‘Accu’ of Table 1. Although the accuracy is not very high (mean of 0.135), it is still much better than random prediction (0.039).

Using the accessibility filter, namely, predicting contacts for only putative core residues (predicted accessibility of less than 0.15), the mean accuracy was significantly improved to 0.236 (‘Accu Core’ column in Table 1).

TABLE 1

| | | | | | | | | | | Accu^{g}- |
|---|---|---|---|---|---|---|---|---|---|---|
| | | | | Mean | Scop | | Random | | Accu | Random |
| PFAM | PDB | #seq | % iden^{b} | length^{c} | class | Random^{d} | Core^{e} | Accu | Core^{f} | Core |
| PF00730 | 1mpgA | 74 | 39 | 137 | a + b | 0.03 | 0.068 | 0.285 | 0.642 | 0.574 |
| PF01354 | 1ops0 | 22 | 29 | 56 | b | 0.095 | 0.242 | 0.4 | 0.8 | 0.558 |
| PF00337 | 1bkzA | 87 | 28 | 131 | b | 0.054 | 0.136 | 0.077 | 0.692 | 0.556 |
| PF00753 | 1bc2A | 329 | 14 | 187 | a + b | 0.04 | 0.083 | 0.588 | 0.588 | 0.505 |
| PF03167 | 1akz0 | 76 | 23 | 159 | a/b | 0.035 | 0.082 | 0.187 | 0.5 | 0.418 |
| PF01814 | 2mhr0 | 310 | 16 | 60 | a | 0.064 | 0.118 | 0.25 | 0.5 | 0.382 |
| PF00075 | 2rn20 | 67 | 46 | 123 | a/b | 0.045 | 0.121 | 0.357 | 0.5 | 0.379 |
| PF00017 | 1bmbA | 58 | 28 | 79 | a + b | 0.071 | 0.208 | 0.286 | 0.571 | 0.363 |
| PF00069 | 1ckiA | 54 | 24 | 228 | a + b | 0.023 | 0.055 | 0.28 | 0.4 | 0.345 |
| PF00127 | 8paz0 | 31 | 31 | 90 | b | 0.076 | 0.192 | 0 | 0.5 | 0.308 |
| PF00581 | 1rhs0 | 49 | 21 | 103 | a/b | 0.044 | 0.112 | 0.25 | 0.416 | 0.304 |
| PF00620 | 1rgp0 | 95 | 26 | 147 | a | 0.029 | 0.063 | 0.214 | 0.357 | 0.294 |
| PF00082 | 1gci0 | 45 | 25 | 273 | a/b | 0.027 | 0.053 | 0.12 | 0.32 | 0.267 |
| PF00406 | 1zin0 | 23 | 43 | 153 | a/b | 0.026 | 0.079 | 0 | 0.333 | 0.254 |
| PF01337 | 1a19A | 16 | 31 | 89 | a/b | 0.056 | 0.127 | 0.25 | 0.375 | 0.248 |
| PF00186 | 3dfr0 | 19 | 31 | 166 | a/b | 0.037 | 0.09 | 0.067 | 0.333 | 0.243 |
| PF03705 | 1af70 | 85 | 21 | 57 | a | 0.049 | 0.164 | 0.2 | 0.4 | 0.236 |
| PF00650 | 1aua0 | 15 | 21 | 148 | a/b | 0.023 | 0.059 | 0.055 | 0.278 | 0.219 |
| PF03171 | 1ipsA | 147 | 24 | 101 | b | 0.057 | 0.106 | 0.3 | 0.3 | 0.194 |
| PF00144 | 2blsA | 130 | 21 | 288 | multi | 0.02 | 0.042 | 0.088 | 0.206 | 0.164 |
| PF03936 | 1ps1A | 87 | 29 | 245 | a | 0.018 | 0.04 | 0.04 | 0.2 | 0.160 |
| PF03900 | 1pda0 | 21 | 31 | 76 | a + b | 0.062 | 0.13 | 0.143 | 0.286 | 0.156 |
| PF00080 | 1eso0 | 28 | 43 | 137 | b | 0.05 | 0.132 | 0.2 | 0.267 | 0.135 |
| PF01739 | 1af70 | 22 | 30 | 192 | a/b | 0.03 | 0.075 | 0.105 | 0.21 | 0.135 |
| PF01088 | 1uch0 | 16 | 33 | 200 | a + b | 0.028 | 0.075 | 0.105 | 0.21 | 0.135 |
| PF00062 | 2ihl0 | 21 | 43 | 106 | a + b | 0.039 | 0.117 | 0.083 | 0.25 | 0.133 |
| PF00384 | 1dmr0 | 32 | 18 | 227 | a/b | 0.015 | 0.024 | 0.043 | 0.152 | 0.128 |
| PF00557 | 1xgsA | 22 | 23 | 226 | a + b | 0.024 | 0.053 | 0.043 | 0.174 | 0.121 |
| PF00607 | 1a8o0 | 16 | 69 | 154 | a | 0.054 | 0.053 | 0.167 | 0.167 | 0.114 |
| PF00018 | 1bu1A | 61 | 27 | 55 | b | 0.12 | 0.305 | 0 | 0.4 | 0.095 |
| PF00112 | 1ppo0 | 162 | 34 | 214 | a + b | 0.034 | 0.064 | 0.19 | 0.143 | 0.079 |
| PF01678 | 1bwzA | 28 | 24 | 120 | a + b | 0.043 | 0.091 | 0.417 | 0.166 | 0.075 |
| PF00067 | 5cp40 | 51 | 21 | 318 | a | 0.015 | 0.031 | 0 | 0.105 | 0.074 |
| PF00580 | 1pjr0 | 41 | 25 | 356 | a/b | 0.01 | 0.023 | 0.065 | 0.087 | 0.064 |
| PF00305 | 1yge0 | 17 | 42 | 520 | a | 0.008 | 0.019 | 0.045 | 0.075 | 0.056 |
| PF00481 | 1a6q0 | 36 | 23 | 248 | a | 0.024 | 0.061 | 0.192 | 0.115 | 0.054 |
| PF00161 | 1bryY | 19 | 31 | 225 | a + b | 0.024 | 0.073 | 0 | 0.125 | 0.052 |
| PF01477 | 1yge0 | 75 | 18 | 110 | b | 0.051 | 0.153 | 0.2 | 0.2 | 0.047 |
| PF00970 | 1fdr0 | 118 | 24 | 93 | b | 0.026 | 0.053 | 0 | 0.1 | 0.047 |
| PF01208 | 1uroA | 15 | 32 | 332 | a/b | 0.017 | 0.041 | 0.088 | 0.088 | 0.047 |
| PF00561 | 1be00 | 49 | 17 | 179 | a/b | 0.022 | 0.04 | 0 | 0.087 | 0.047 |
| PF00235 | 1a0k0 | 16 | 42 | 123 | a + b | 0.043 | 0.127 | 0 | 0.167 | 0.040 |
| PF00565 | 1nuc0 | 18 | 23 | 128 | b | 0.044 | 0.114 | 0.077 | 0.153 | 0.039 |
| PF00162 | 16pk0 | 25 | 45 | 350 | a/b | 0.015 | 0.033 | 0.048 | 0.048 | 0.015 |
| PF00963 | 1aohA | 42 | 26 | 142 | b | 0.048 | 0.14 | 0.214 | 0.143 | 0.003 |
| PF01273 | 1bp10 | 40 | 18 | 165 | a + b | 0.021 | 0.06 | 0.059 | 0.059 | −0.001 |
| PF02906 | 1fehA | 18 | 36 | 270 | a + b | 0.018 | 0.04 | 0.067 | 0.033 | −0.007 |
| PF01379 | 1pda0 | 21 | 44 | 208 | a/b | 0.027 | 0.057 | 0.1 | 0.05 | −0.007 |
| PF00882 | 1ah70 | 62 | 49 | 262 | a | 0.02 | 0.054 | 0 | 0.041 | −0.013 |
| PF00034 | 1ctj0 | 50 | 21 | 83 | a | 0.054 | 0.139 | 0.125 | 0.125 | −0.014 |
| PF03013 | 2end0 | 32 | 58 | 136 | a | 0.032 | 0.094 | 0.077 | 0.077 | −0.017 |
| PF01400 | 1iae0 | 29 | 35 | 186 | a + b | 0.03 | 0.081 | 0.21 | 0.053 | −0.028 |
| PF01565 | 2mbr0 | 147 | 21 | 131 | a + b | 0.029 | 0.053 | 0 | 0 | −0.053 |
| PF00014 | 2hexA | 153 | 34 | 54 | small | 0.108 | 0.256 | 0.2 | 0.2 | −0.056 |
| PF00111 | 1fehA | 217 | 23 | 70 | a + b | 0.063 | 0.227 | 0 | 0.166 | −0.061 |
| PF00694 | 1amj0 | 19 | 32 | 125 | a/b | 0.04 | 0.09 | 0 | 0 | −0.090 |
| PF00042 | 1flp0 | 76 | 28 | 125 | a | 0.03 | 0.091 | 0.083 | 0 | −0.091 |
| PF01568 | 1dmr0 | 56 | 23 | 112 | b | 0.042 | 0.123 | 0.1 | 0 | −0.123 |
| PF01320 | 1ayi0 | 41 | 49 | 86 | a | 0.046 | 0.19 | 0.25 | 0 | −0.190 |
| Mean± | | 63.24± | 30.3± | 167.13± | | 0.039± | 0.098± | 0.135± | 0.236± | 0.137± |
| Std Err | | 8.50 | 1.41 | 11.81 | | 0.002 | 0.008 | 0.016 | 0.024 | 0.022 |

^{a}fraction of correct prediction out of the L/10 top predicted contacts using the pair-to-pair substitution matrix provided in file P2Pmat.txt embodied in enclosed CD-ROM 1.
^{b}mean sequence identity between pairs of sequences in the multiple alignment
^{c}mean length (L)of sequences in the alignment
^{d}The expected accuracy of random prediction based on all possible and real contacts in the protein
^{e}The expected accuracy of random prediction based on all possible and real contacts of residues assumed to be in the core of the protein (predicted accessibility <0.15)
^{f}Fraction of correct predictions out of the L/10 top predicted contacts between residues assumed to be in the core of the protein (predicted accessibility <0.15)
^{g}Fraction of correct predictions out of the L/10 top predicted contacts minus expected accuracy of random prediction between residues assumed to be in the protein core (predicted accessibility <0.15).

Similar results were obtained for this set with pair-to-pair substitution matrices prepared, according to various exemplary embodiments of the present invention, from larger input of Blocks data. Another study was conducted using an independent set of 67 proteins. This study is further detailed hereinunder in Example 3 and Table 4.

Table 2 below summarizes the accuracies (for L/10) obtained using other pair-to-pair substitution matrices. The columns of Table 2 correspond to different matrices and refer to file names in enclosed CD-ROM 1.

TABLE 2

| | pair-to-pair substitution matrix | | |
|---|---|---|---|
| protein set | P2Pmat.txt | P2Pmat14Intra.txt | P2Pmat14Burried.txt |
| 59 families | 13.8 | 13.3 | 14.1 |
| (see Table | | | |
| 1) all | | | |
| 59 families | 23.6 | 22.3 | 20.1 |
| (see Table | | | |
| 1) core | | | |
| 67 families | 11.2 | 12.8 | — |
| (see Table | | | |
| 4) all | | | |
| 67 families | 22.6 | 22.1 | — |
| (see Table | | | |
| 4) core | | | |

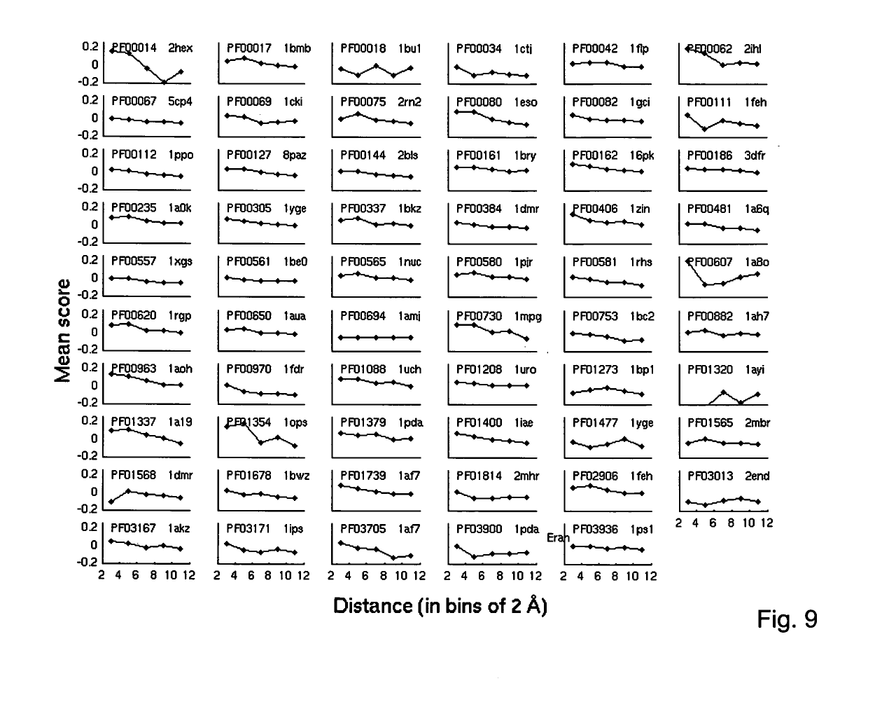

FIG. 9 shows the relation between scores of the method of the present embodiments for pairs of core residues and their actual distance in all 59 test set representative structures summarized in Table 1. As shown, in most of the families, pairs of core residues that are close in space obtain higher scores by the method of the present embodiments. For approximately 90% of the families, a clear trend for higher scores in closer distances is observed. For most of these families, the trend was also monotonic.

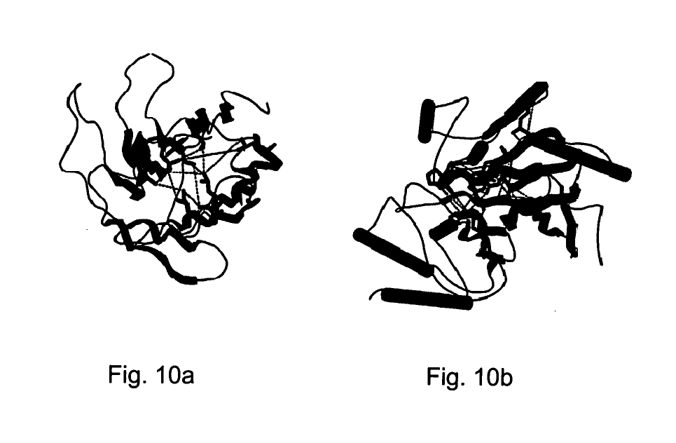

FIGS. 10a-b show examples of contact prediction for two protein families. For the prediction of L/10 contacts in the core, the prediction accuracy in these examples was 0.69 for the Galactoside-binding lectins family (β SCOP class) (FIG. 10a), and 0.59 for the Metallo-beta-lactamase superfamily (α+β SCOP class) (FIG. 10b). The lectins family has a sandwich topology with a tight association between a five-stranded and seven-stranded β-sheets. More than half of the best 13 predicted contacts are between residues from the two sheets. These contacts are likely to be important for the protein topology organization.

In the metallo-beta-lactamase superfamily, many of the predicted contacts included one of two histidine residues (86 and 88), which are almost fully conserved in known metallo-beta-lactamase sequences. These histidines are part of a zinc active site. Contacts between residues of a second zinc binding site (Asp90, Cysl68 and His210) were also well predicted. This example suggests the importance of intra-protein contacts for correct orientation and nature of functional sites. It shows how the predicted contacts are likely to be important for protein topology organization and their importance for correct orientation and nature of functional sites.

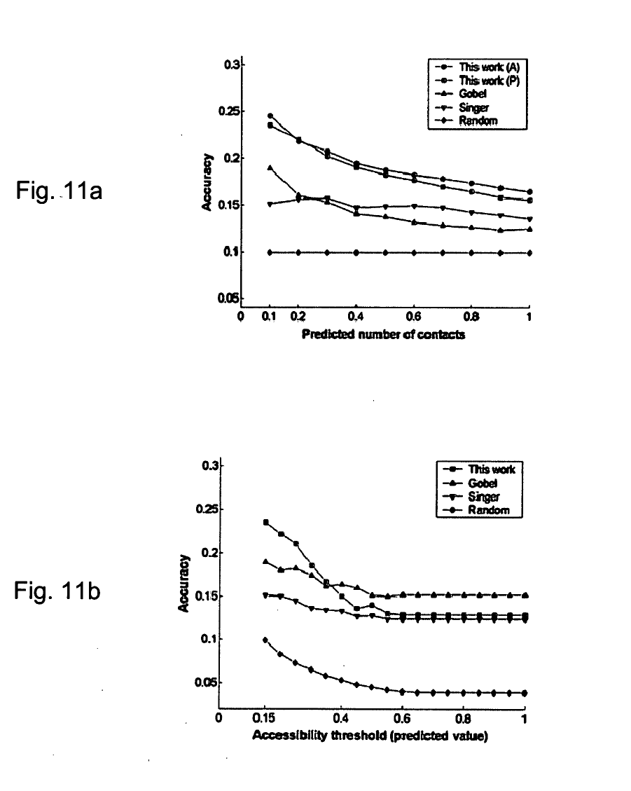

FIGS. 11a-b show a comparison between the method of the present embodiments and the methods of Gobel et al. and Singer et al.

FIG. 11a shows contact prediction accuracies in protein cores as a function of the predicted number of contacts. The predicted number of contacts is shown as a fraction of the protein length. Prediction accuracies of the method of the present embodiments, with core residues identified from structural data, are shown by circles (A). Prediction accuracies of the method of the present embodiments, with core residues predicted from sequence data using SABLE are shown by squares (P). Core residues are defined as those with solvent accessibility smaller than 0.15 (lowest value in (b)).

As shown in FIG. 11a, the method of the present embodiments has an improved accuracy of 1.26 and 1.60 fold over the prior art methods (24% vs. 19% and 15%). This difference is more prominent for predicting small number of contacts, but is also present when predicting more contacts. The Sensitivity of the method of the present embodiments to inaccuracies of solvent accessibility predictions was examined by using actual solvent accessibility (calculated from resolved structures) instead of the predicted solvent accessibility. This only marginally improved the results (see FIG. 11a, circles vs. squares respectively), showing that SABLE accessibility predictions are very well suited for use in the method of the present embodiments. The correlation coefficient between SABLE predicted accessibilities and actual accessibilities is 0.67, in accordance with the teachings of Adamczak et al.

FIG. 11b shows contact prediction accuracies as a function of the solvent accessibility threshold. Shown are mean prediction accuracies of L/10 contacts of all families in the test set (lowest value in (a)). For each solvent accessibility threshold, only residues with predicted solvent accessibility smaller than this filter were considered.

As shown in FIG. 11b, when predicting contact for core residues, the use of P2PMAT is superior to the prior art methods. Thus, the use of P2PMAT in combination with one or more supplementary algorithms is expected to be a synergy in the prediction capacity. FIG. 11b demonstrates that for accessibility filters of 0.35 and below, the method had the best accuracy. A similar trend was observed for the prediction of larger number of contacts (data not shown).

Table 3, below compares between the method of the present embodiments and the PlotCorr program.

The PlotCorr program is an improvement of Gobel's method. The major source of the improvement is the use of structural features (contact occupancy). The data in Table 3 demonstrate that the PlotCorr method performs equally to the method of the present embodiments for prediction of contacts in the protein core, in spite of the fact that the method of the present embodiments does not make use of structural contact occupancy for the prediction. The reduction in the accuracy shown in Table 3 compared to the accuracy found in the overall comparison (22% vs. 24%, respectively) may be explained due to the use of different alignments (HSSP and Pfam, respectively).

TABLE 3

| | L/10 | | L/2 | |
|---|---|---|---|---|
| | | Accu | | Accu |
| | Accu | core | Accu | core |
| Olemea and | 0.19 ± 0.14 | 0.22 ± 0.14 | 0.12 ± 0.07 | 0.16 ± 0.08 |
| Valencia | | | | |
| The present | 0.15 ± 0.13 | 0.22 ± 0.16 | 0.10 ± 0.07 | 0.17 ± 0.09 |
| embodiments | | | | |

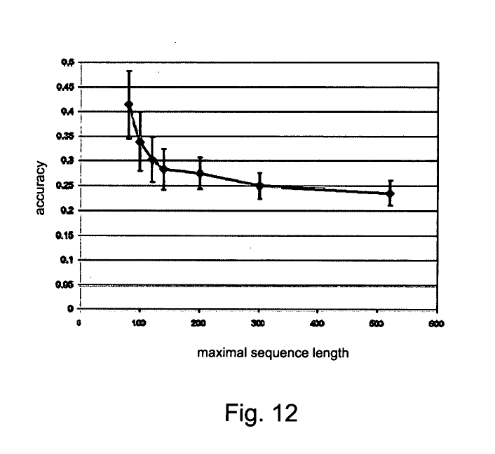

FIG. 12 shows the mean contact prediction accuracy in proteins core for proteins with different maximal lengths. Standard error values are shown for each accuracy value. The values are calculated from the data shown in Table 1 (columns Mean length and Accu. Core). It is known that the prediction accuracy is lower for large proteins, because the number of real contacts increases linearly with the protein length, while the number of possible contacts is a quadratic function of the protein length. For families of small proteins (mean length of less than 100 residues) the L/10 accuracy of the contact prediction in the core was 0.34±0.21, while for families of large proteins (a mean length of more than 100 residues) it was 0.21±0.17. The mean prediction accuracy gradually declines from 41% to 24% when the proteins maximal mean length is increased from 80 to 520 residues.

With respect to the dependence of the prediction accuracy on the number of sequences in the alignment, it was found that for alignments with more than 35 sequences the mean accuracy was 0.26±0.20, while for alignments with less than 35 sequences where the accuracy was 0.21±0.17.

The influence of the sequence similarity level of an alignment (the mean identity of sequence pairs in the alignment) on the prediction accuracy was also investigated. Typically, using less similar sequences in alignments can improve contact prediction accuracy. It was found that the prediction accuracy for families with mean identity of less than 30% was better (0.27±0.20) than for alignments with mean pair-wise sequence identity of more than 30% (0.20±0.17).

FIG. 13 shows the evaluation of decoy structure sets using the pair-to-pair substitution matrix of the present embodiments. Shown in FIG. 13 is the rank of each decoy (in percentage of the total number of decoys) as a function of its root-mean-square-distance (RMSD) to the native structure. The native structure points appear in FIG. 13 as triangles and have zero RMSD values. For each protein, the PDB id of the native structure is given along with the source from which the decoy structures were obtained. Specifically, proteins labeled in FIG. 13 by ‘ro’ were obtained from Tsai et al., “An improved protein decoy set for testing energy functions for protein structure prediction”, Proteins 2003; 53:76-87; proteins labeled in FIG. 13 by ‘du’ were obtained from Samudrala R and Levitt M., “Decoys ‘R’ Us: a database of incorrect conformations to improve protein structure prediction”, Protein Sci 2000; 9:1399-1401; and proteins labeled in FIG. 13 by ‘aw’ were obtained from Wang et al., “Discriminating compact normative structures from the native structure of globular proteins”, Proc Natl Acad Sci USA 1995; 92:709-713.

Unlike other scoring functions which are based on physical interactions, the prediction according to the present embodiment is based on the pair-to-pair substitution matrix, which embodies evolutionary information. As demonstrated in FIG. 13, the technique of the present embodiments generally ranks the native structures in the top structures in the evaluation. Two out of ten times it is ranked first, in two other cases it is ranked among the top 0.3% of the decoys, and in four other cases it is ranked among the top 10%. Only in two cases the native structure was not ranked among the best 10% of the decoys. It is therefore demonstrated the method of the present embodiments is capable of predicting the native structure of the protein for a given set of decoy structures.

Some of the sets obtained from Tsai et al., included subsets of decoys which were constructed to be closer to the native. In these cases the subsets typically had better scores than the rest of the decoys.

Analysis of only buried positions did not improve the results. It is assumed that the signal of solvent exposed sites, despite being very weak, can contribute to the overall discrimination ability of close to native structures.

### Discussion

The ability of the prototype matrix to facilitate contact prediction was investigated. The prototype matrix includes an implicit combination of evolutionary conservation, contact potential and correlated mutations data by integrating known protein structures and pair-to-pair substitution frequencies from accurate multiple sequence alignments.

Scoring the relation between two highly conserved columns is known as problematic issue for correlated mutations analysis. Some prior art methods score totally conserved columns as zero, yet others give it the maximal possible score. The P2PMAT matrix of the present embodiments gives mainly intermediate scores to invariant events (x,y [symbol] x,y) (see FIG. 1a) reflecting the fact that they are typically less informative for contact prediction, or detecting other types of correlations. Yet some specific invariant events, such as (Cys,Cys [symbol] Cys,Cys), (Cys,His [symbol] Cys,His), and (His,His [symbol] His,His), get high scores in the P2PMAT matrix. The preservation of a cysteine pair indicates a possible disulfide bonds, only possible between a pair of this rare amino acid.

High scores for invariant (His,Cys) and (His,His) pairs may be due to metal binding sites that specifically require only these residues. Some particularly low scores are given for flipped pairs that include Trp and Tyr aromatic residues (Gln, Asn and Pro with both Trp and Tyr, and Gly, Val, Cys, Lys, Glu and Asp with either Trp or Tyr).

The low contact likelihood upon such substitutions could be due to specific contact orientations of these large aromatic residues. Incorporating information on invariant events along with the directly informative correlated changes by the method of the present embodiments is, therefore, straightforward and effective.

The method of the present embodiments is capable of predicting contacts in protein cores where it out-performs other comparable approaches (see FIG. 11b). The structural constraints make the substitution matrix of the present embodiments more informative inside protein. The predicted accuracy is essentially the same either for calculated or predicted accessibility values. This is particularly useful for problems in which it is required to predict a three-dimensional structure of a protein without any fold information. The 24% accuracy level attained by the method of the present embodiments is beyond the 22% contact prediction threshold of ab initio protein structure prediction.

The time complexity of the above calculation is O(N²L²), where N is the number of sequences in the alignment and L is the alignment length. The program is fast, avoiding computational demanding tasks, such as bootstrapping or constructing many phylogenetic trees. It is, thus, well suited for complex and demanding tasks, and for high throughput analysis.

### Example 3

### Graph Analysis

In the present example, a preferred technique for predicting amino acid contacts from the pair scores is provided. The preferred technique includes the construction and analysis of a mathematical graph.

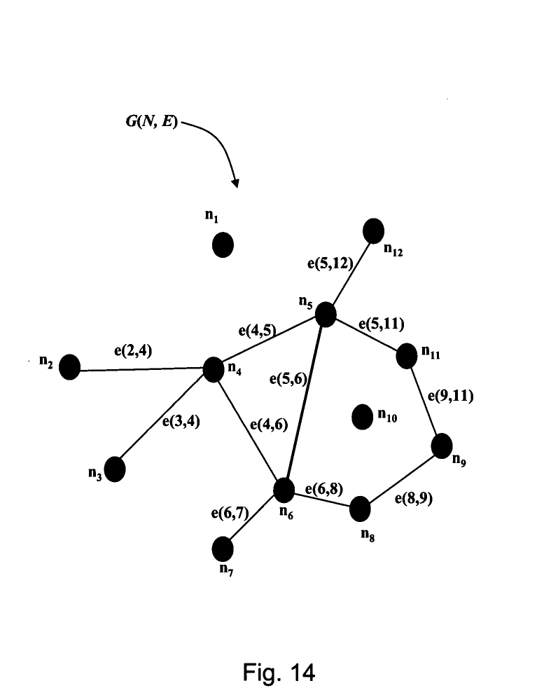

FIG. 14 is a schematic illustration of graph G(N,E), composed of a plurality of nodes nᵢ, and a plurality of edges e(i,j) interconnecting node nᵢ with node nⱼ. The nodes correspond to amino acids (columns in the alignment), and the edges correspond to the contacting amino acids (with sufficiently high contact probabilities). The graph can also be a weighted graph in which edge e(i,j) is associated with a weight which equals scoreᵢⱼ (see Equation 1).

In various exemplary embodiments of the invention the highly connected regions on the graph are searched by the mutual clustering coefficient algorithm. For each edge between nodes i and j, the mutual clustering coefficient cᵢⱼ compares the number of edges that connect nodes i and j through one additional node with the number of such connecting edges expected from all the edges in which i and j participate. There are several mutual clustering coefficients which are contemplated.

In one embodiment a purely geometric approach is employed without considering the weights assigned to each edge (or by assigning weight 1 to all edges). In this embodiment, the graph topology is used to determine, for each edge, the fraction of edges which are connected to both nodes of the edge. The fraction can be determined, for example, by calculating the square root of product of the edges connected to each of the connected nodes.

Geometric mutual clustering coefficients can be calculated according to the following formula:

cᵢⱼ=|N(i)∩N(j)|²/|N(i)|·|N(j)| (EQ. 8)

where N(i) denotes the neighbors of node i and is defined as N(i)={k|k i εG}. Another alternative for calculating the geometric mutual clustering coefficients is by replacing the right-hand-side of Equation 8 by the square root thereof.

In another embodiment, a Jaccard index can be used for calculating the mutual clustering coefficients:

Cᵢⱼ=|N(i)∩N(j)|/|N(i)∪N(j)|, (EQ. 9)

These coefficients are a well-known to those skilled in graph theory, and have been widely used for hierarchical clustering. The Jaccard index is particularly useful when both endpoints i and j of edge e(i,j) have sufficiently small neighborhoods.

In a further embodiment, the following mutual clustering coefficients are used:

Cᵢⱼ=|N(i)∩N(j)|/min(|N(i)|,|N(j)|), (EQ. 10)

These coefficients are well-known to those skilled in graph theory, and are particularly useful to resolve bias caused by, e.g., large neighborhood for one of the two endpoints of the edge.

In another embodiment, a P-value is calculated for the common edges using a hyper-geometric distribution.

In an additional embodiment, the mutual clustering coefficients depend on the weights of the edges. This can be done by defining, for each edge e(i,j), a mutual clustering coefficient cᵢⱼ which can be, for example, the sum of scores of all edges forming triangles with e(i,j). Preferably, cᵢⱼ is normalized with the sum of scores for all the edges that are connected to e(i,j). Referring to FIG. 14, the mutual clustering coefficient which is assigned, e.g., to edge e(5,6) (emphasized in red) is preferably defined as S₁(5,6)/S₂(5,6), where S₁(5,6) is the sum of scores (scoreᵢⱼ) along the triangle formed by e(4,5), e(5,6) and e(4,6), and S₂(5,6) is the sum of scores of edges e(4,5), e(5,6), e(4,6), e(6,7), e(5,11), e(6,8) and e(5,12).

Formally, cᵢⱼ can be defined as:

$${c}_{ij} = {\sum }_{k ∈ N ( i ) ⋂ N ( j )} ( {score}_{ki} + {score}_{kj} ) - ( \begin{matrix}{\sum }_{k ∈ N ( i ) , k \neq j} {score}_{ki} + \\ {\sum }_{k ∈ N ( j ) , k \neq i} {score}_{kj}\end{matrix} ) , \qquad ( EQ . 11 )$$

Note that the edge e(i,j) is not a part of either sum.

When the scores of the edges are expressed as log odds, the calculation is preferably preceded by a step in which the terms in each sum are transformed from log odds to probabilities, so as to avoid possible divisions by 0. As will be appreciated by one ordinarily skilled in the art, such procedure results in a mutual clustering coefficient in the range 0<cᵢⱼ≦1.

To score edges being near other edges in the primary protein sequence, a moving window procedure is preferably employed. The alignment is preferably scanned using a window of width 2w+1, where w is a predetermined parameter. Thus, for each column i in the alignment, a window is defined from column i−w to column i+w, where for columns with i<w or L−i<w the window is narrower and is preferably defined from column 1 to column i+w, or from column i−w to column L, respectively. On the corresponding weighted graph G, a window-score can be calculated for each edge e(i,j). This is preferably performed by summing the all the edge scores of the edges in the region [e(i−w,j), e(i,j+w)] on G. In various exemplary embodiments of the invention the window-score is normalized by the number of all possible edges. The (maximal) window width is preferably selected such as to allow handling of secondary structures of proteins (strands, helices), which typically include about 5 residues. Thus, the value for the parameter w is preferably from 1 to 3 (say, w=2) resulting in a window width which is from 3 to 7.

Alternatively, the window can be calculated using a portion of the multiple alignment. For example, according to a preferred embodiment of the present invention the window can be calculated using a particular sequences in the alignment. This embodiment is particularly useful when in applications in which it is desired to predict three-dimensional structure of a particular protein, whereby the multiple alignment, which represents the protein's family, only serves for better characterizing the protein of interest. The advantage of this embodiment is that it eliminates the ambiguity of alignment gaps and positions of undetermined structure where it is sometimes unclear whether they should be counted in calculating the window or not.

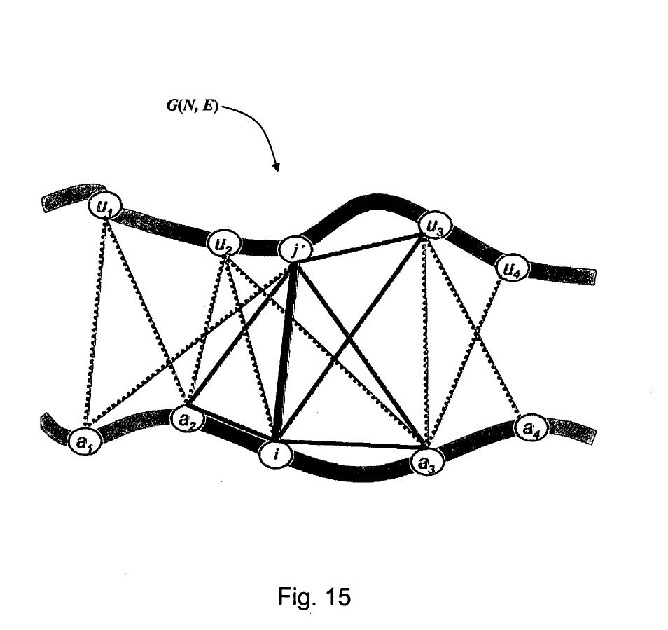

A schematic example for the calculation of a mutual clustering coefficient cᵢⱼ for an edge e(i,j) and window averaging is illustrated in FIG. 15, showing nodes i and j which are the endpoints of the analyzed edge as well as eight other nodes u₁, u₂, u₃, u₄, a₁, a₂, a₃ and a₄. Nodes are shown as circles and edges are shown as lines. A part of the protein backbone sequence is shown as thick wavy lines. The analyzed edge e(i,j) is shown as a thick line and edges connecting nodes i and j through a third node (a₂, a₃ or u₃ in the present example), are shown as thinner lines. Other edges are shown as dotted line. The mutual clustering coefficient cᵢⱼ compares the number of edges connecting nodes i and j through a third node, or their integrated weights, with the number, or weight, expected from all edges, in which i or j are present. The five top nodes (u₁, u₂, j, u₃ and u₄) and five bottom nodes (a₁, a₂, i, a₃ and a₄) form the sequence window for nodes j or i, respectively. Iv various exemplary embodiments of the invention edge e(i,j) is given the mean cᵢⱼ value of all edges between the two windows

It is appreciated that the window-scores are independent of the mutual clustering coefficients. Thus, the window-scores can be calculated using the mutual clustering coefficients and/or the raw scores.

The present embodiments thus contemplate at least 6 types of scores which can be calculated for the edges of G(N,E). These include, (i) raw scores scoreᵢⱼ (ii) window-scores as calculated for the raw scores, (iii) geometric scores without weight, (iv) window-scores as calculated for geometric scores without weights, (v) weighted geometric scores, and (vi) weighted geometric scores. Other types of scores and combinations of scores are also contemplated.

Any of the above scores can be used, or, alternatively, an optimization procedure can be employed to determine which score is most suitable for contact or three-dimensional structure prediction. This can be done, for example, by evaluating the performance of the prediction procedure, for each type of score, on one or more test sequences with known structure and multiple sequence alignment.

The optimization can be performed on the entire test sequence or a portion thereof (e.g., its hydrophobic core) as desired. Edges to structurally undefined positions (such as sequence residues which are not present in the structure), and to positions that are inserts relative to the structure are preferably removed from the graph.

The performance of the prediction procedure can be evaluated in terms of any known measure, including, without limitation, accuracy, defined as the fraction of correct prediction in the top scores to the total number of predictions in the top scores; coverage, is defined as the fraction of correct prediction in the top scores to the total number of actual contacts. The performance of the prediction procedure can also be compared relative to other known methods or to random choice. The predictions can be selected according to the length L of the multiple sequence alignment, as further detailed in Example 2 above. Additional measures which can be used include standard scores (e.g., Z scores, T scores), percentile ranks and the like.

The graph analysis technique described above was optimized using a training set of 59 structures (see Table 1 in Example 2). The representation of predicted contacts as graphs enables the identification of highly connected regions or local clusters in the graph. Sparse graphs were created from top scoring predictions (edges) and graph analysis was performed with and without considering edge weights.

The four types of mutual clustering coefficients described above (Equations 8-11) were used to search the graph for edges with high neighborhood cohesiveness (edges that are part of a well connected graph regions). High correlation was found between all unweighted coefficients (Equations 8-10). Further analysis was therefore performed using Geometric unweighted coefficients (Equation 8) and Jaccard weighted coefficients (Equation 11). The number of top scoring prediction used to create the graph was also examined. It can be defined by a threshold score, as a fraction of the number of all possible predictions, or as a fraction of the protein/MSA length (L). Graph edge selection was examined using different fractions of the top prediction scores (0.25, 0.20, 0.15, 0.10, 0.05 or 0.01), or by taking predictions with scores equal or above a given z-score (1.0, 1.5, 2.0, 2.5, 3.0, 3.5 or 4).

Edges being near other edges in the primary protein sequence were scored using the moving window procedure, as further detailed hereinabove. This procedure utilizes the modular-nature of protein structure, where secondary structure elements (usually strands with strands and helices with helices) often interact with each other by several contacts. Two values for window width were used: a window of five residues (corresponding to w=2) and a window of seven residues (corresponding to w=3), both widths are shorter than typical helices and strands. Evaluations were done with the top scoring L/10 pairs. The optimal parameters for the training set were found to be: the pair-to-pair substitution matrix provided in file P2Pmat14Intra.txt in enclosed CD-ROM 1, analysis of top 5% contact prediction scores, a window of five residues (w=2), and the geometric unweighted mutual clustering coefficients.

Using the above parameters, the graph analysis technique of the present embodiments was applied on a different set of 67 proteins obtained from the PFAM database. Contact predictions were obtained for each of the 67 proteins, both using all the columns of the multiple sequence alignments and using only columns predicted to be in the protein core. The contact predictions were obtained using four different predicting methods.

A first method, referred to hereinbelow as method 1, was a conventional method employing the PlotCorr package of Pazos et al. and Olemea et al. (supra). The parameters for this method were the default parameters in which the contact predictions are for residues spaced apart by at least 6 amino acids on the primary sequence-D6), and the L/10 top scores were selected.

A second method, referred to hereinbelow as method II, was the PlotCorr package supplemented with the graph analysis technique according to a preferred embodiment of the present invention.

A third method, referred to hereinbelow as method III, employed a pair-to-pair substitution matrix prepared according to a preferred embodiment of the present invention. The matrix-elements are provided in file P2Pmat14Intra.txt in enclosed CD-ROM 1. To allow comparison with methods I and II, this method was executed using the same parameters (contact predictions for residues spaced apart by at least 6 amino acids on the primary sequence and selecting the L/10 top scores).

A fourth method, referred to hereinbelow as method IV, was method III supplemented with the graph analysis technique according to a preferred embodiment of the present invention.

The results are summarized in Table 4, below. In Table 4, the leftmost three columns list the input data (multiple sequence alignment accessions of the PFAM database, mean length of the multiple sequence alignment, and names of the PDB files) and the other columns lists the contact prediction accuracy for each of the four methods described above.

TABLE 4

| | | | PlotCorr package | | | | Pair to Pair Substitution Matrix | | | |
|---|---|---|---|---|---|---|---|---|---|---|
| | Mean | | all proteins | | predicted cores | | all proteins | | predicted cores | |
| PFAM ID | Length | PDB | I | II | I | II | III | IV | III | IV |
| PF00018 | 56.459 | 1uecA | 0 | 0.33 | 0.25 | 0.25 | 0 | 0.4 | 0.17 | 0.17 |
| PF00021 | 75.881 | 1erg | 0.125 | 0.125 | 0.2 | 0.2 | 0.5 | 0 | 0.25 | 0.625 |
| PF00024 | 82.6667 | 1bhtA | 0.17 | 0 | 0 | 0 | 0.25 | 0.125 | 0.4 | 0.4 |
| PF00030 | 82.7297 | 1npsA | 0.25 | 0.25 | 0.57 | 0.58 | 0.25 | 0.375 | 0.5 | 0.625 |
| PF00051 | 79.3333 | 1nl1A | 0.25 | 0 | 0.67 | 0.67 | 0.125 | 0.125 | 0.25 | 0.25 |
| PF00068 | 119.973 | 1aokB | 0.083 | 0 | 0.2 | 0.2 | 0 | 0.08 | 0.17 | 0.17 |
| PF00079 | 374.902 | 1as4A | 0.065 | 0.027 | 0 | 0 | 0.083 | 0.067 | 0.05 | 0.03 |
| PF00080 | 152 | 1flgA | 0.13 | 0.2 | 0.27 | 0.27 | 0.67 | 0.27 | 0.47 | 0.53 |
| PF00092 | 178.969 | 1mjnA | 0.44 | 0.56 | 0.2 | 0.2 | 0.33 | 0.56 | 0.125 | 0.125 |
| PF00104 | 85.1613 | 1xpcA | 0.11 | 0.11 | 0.33 | 0.33 | 0 | 0.11 | 0.11 | 0.11 |
| PF00105 | 76.2593 | 1r0oB | 0 | 0 | 0 | 0 | 0.375 | 0.25 | 0.125 | 0.125 |
| PF00109 | 247.707 | 1tqyG | 0.12 | 0.4 | 0.12 | 0.36 | 0.059 | 0.44 | 0.28 | 0.44 |
| PF00111 | 74.2765 | 1awd | 0 | 0 | 0 | 0.14 | 0.71 | 0.14 | 0.86 | 0.72 |
| PF00121 | 240.232 | 1kv5A | 0.21 | 0.17 | 0.17 | 0.22 | 0.25 | 0.125 | 0.083 | 0.21 |
| PF00160 | 160.455 | 1vaiA | 0.19 | 0.19 | 0.31 | 0.375 | 0.19 | 0.125 | 0.31 | 0.375 |
| PF00169 | 109.972 | 1btkA | 0.27 | 0.73 | 0.55 | 0.64 | 0 | 0.36 | 0.64 | 0.55 |
| PF00173 | 78.8028 | 1mj4A | 0 | 0 | 0.625 | 0.63 | 0 | 0 | 0.625 | 0.625 |
| PF00175 | 106.822 | 1qfzA | 0.09 | 0 | 0.36 | 0.45 | 0 | 0 | 0.36 | 0.55 |
| PF00185 | 151.762 | 1duvG | 0.125 | 0.063 | 0.25 | 0.38 | 0 | 0 | 0.19 | 0.25 |
| PF00188 | 158.238 | 1u53A | 0.38 | 0.31 | 0.15 | 0.23 | 0.23 | 0.15 | 0.31 | 0.38 |
| PF00198 | 231.227 | 1eab0 | 0.17 | 0.26 | 0.13 | 0.17 | 0.09 | 0.09 | 0.09 | 0.13 |
| PF00216 | 90.6049 | 1b8zA | 0.17 | 0 | 0.11 | 0.13 | 0 | 0 | 0 | 0 |
| PF00218 | 254.4 | 1jul | 0 | 0 | 0 | 0 | 0.17 | 0.05 | 0.04 | 0.04 |
| PF00303 | 292.867 | 1bkpA | 0.07 | 0.03 | 0.03 | 0 | 0.069 | 0 | 0.03 | 0 |
| PF00306 | 110.437 | 1skyB | 0.09 | 0.11 | 0.09 | 0.3 | 0.09 | 0 | 0.18 | 0.4 |
| PF00326 | 214.643 | 1o6gA | 0.25 | 0.1 | 0.24 | 0.1 | 0.25 | 0.048 | 0.14 | 0 |
| PF00337 | 137.931 | 1lcl | 0.15 | 0.29 | 0.5 | 0.57 | 0.15 | 0.71 | 0.5 | 0.64 |
| PF00340 | 134.5 | 1iraX | 0.077 | 0.38 | 0.62 | 0.39 | 0.08 | 0.46 | 0.62 | 0.23 |
| PF00349 | 206.533 | 1v4sA | 0.077 | 0.1 | 0.14 | 0.05 | 0.08 | 0.048 | 0.06 | 0.11 |
| PF00401 | 47.125 | 1e79H | 0 | 0 | 0 | 0 | 0 | 0 | 0 | 0 |
| PF00410 | 130.2 | 1an7A | 0.15 | 0.23 | 0.31 | 0.23 | 0.15 | 0.31 | 0.54 | 0.69 |
| PF00459 | 274.123 | 1ka1A | 0.04 | 0.26 | 0.04 | 0.33 | 0.07 | 0.15 | 0.19 | 0.3 |
| PF00505 | 69.0667 | 1hmf | 0 | 0 | 0 | 0 | 0 | 0 | 0 | 0 |
| PF00510 | 256.81 | 2occB | 0 | 0 | 0 | 0 | 0 | 0 | 0.039 | 0.15 |
| PF00511 | 78.9565 | 1f9fD | 0.125 | 0.375 | 0.5 | 0.5 | 0 | 0.625 | 0.375 | 0.75 |
| PF00554 | 173.095 | 1iknA | 0.059 | 0.24 | 0.29 | 0.35 | 0.12 | 0.29 | 0.35 | 0.3 |
| PF00556 | 40.7333 | 1ijdA | 0 | 0 | 0 | 0 | 0 | 0 | 0 | 0 |
| PF00565 | 137.167 | 1ihzA | 0 | 0.08 | 0.21 | 0.22 | 0 | 0 | 0.07 | 0.3 |
| PF00595 | 83.2241 | 1iu0A | 0.375 | 0.25 | 0.25 | 0.38 | 0.125 | 0.5 | 0.375 | 0.625 |
| PF00615 | 121.55 | 1omwA | 0.083 | 0 | 0.17 | 0.17 | 0.08 | 0.083 | 0.33 | 0.33 |
| PF00732 | 264.571 | 1cf3A | 0 | 0 | 0.15 | 0.08 | 0 | 0.15 | 0.08 | 0.19 |
| PF00754 | 128.54 | 1w8oA | 0.62 | 0.54 | 0.38 | 0.7 | 0.38 | 0.54 | 0.38 | 0.69 |
| PF00759 | 452.15 | 1rq5A | 0.04 | 0 | 0.067 | 0.09 | 0.089 | 0.067 | 0.16 | 0.13 |
| PF00775 | 182.762 | 1dlmB | 0.22 | 0.28 | 0.44 | 0.28 | 0.11 | 0.11 | 0.17 | 0.11 |
| PF00809 | 209.071 | 1q8aA | 0 | 0 | 0 | 0.05 | 0.05 | 0.05 | 0 | 0 |
| PF00840 | 422.889 | 1celA | 0 | 0.02 | 0.02 | 0.12 | 0.12 | 0.12 | 0.07 | 0.12 |
| PF01011 | 38.1832 | 1kb0A | 0.25 | 0 | 0 | 0 | 0.25 | 0.25 | 0.33 | 0.33 |
| PF01063 | 283.72 | 1iyeA | 0.036 | 0.18 | 0.04 | 0.14 | 0.11 | 0.14 | 0.18 | 0.11 |
| PF01179 | 422.067 | 1rjoA | 0.13 | 0.03 | 0.07 | 0.07 | 0.1 | 0.12 | 0.07 | 0.12 |
| PF01225 | 88.3571 | 1p3dA | 0 | 0.125 | 0 | 0 | 0 | 0.22 | 0 | 0.22 |
| PF01273 | 170.526 | 1ewfA | 0.059 | 0.06 | 0.06 | 0.12 | 0.06 | 0.18 | 0.059 | 0.06 |
| PF01322 | 123.5 | 1e85A | 0.09 | 0 | 0 | 0 | 0 | 0 | 0.08 | 0 |
| PF01354 | 57.7727 | 1xuzA | 0.33 | 0.5 | 0.83 | 0.84 | 0.33 | 0.67 | 0.8 | 0.83 |
| PF01419 | 132.385 | 1ouwD | 0.15 | 0 | 0 | 0.08 | 0.15 | 0.15 | 0.08 | 0.08 |
| PF01453 | 112.072 | 1kj1D | 0.45 | 0.18 | 0.27 | 0.46 | 0.5 | 0.4 | 0.18 | 0.55 |
| PF01645 | 372.6 | 1llwA | 0.05 | 0.11 | 0.05 | 0.17 | 0.05 | 0.14 | 0.054 | 0.11 |
| PF01729 | 170.368 | 1qpoA | 0.06 | 0 | 0.12 | 0.18 | 0.06 | 0 | 0.12 | 0.12 |
| PF01820 | 120.588 | 1e4eB | 0.33 | 0.17 | 0.08 | 0.25 | 0.11 | 0.25 | 0.33 | 0.5 |
| PF02234 | 50.2273 | 1jsuB | 0 | 0 | 0 | 0 | 0 | 0.6 | 0.2 | 0.4 |
| PF02332 | 230.304 | 1fz1C | 0 | 0 | 0.13 | 0.13 | 0 | 0.04 | 0.09 | 0.04 |
| PF02629 | 100.138 | 1oi7A | 0.2 | 0.1 | 0.3 | 0.2 | 0.2 | 0.1 | 0 | 0.1 |
| PF02866 | 171.053 | 1iz9A | 0 | 0 | 0 | 0 | 0.0625 | 0 | 0.12 | 0 |
| PF02919 | 217.25 | 1ois | 0.1 | 0.14 | 0.23 | 0.23 | 0.13 | 0.14 | 0.14 | 0.23 |
| PF03123 | 58.8 | 1h99A | 0 | 0 | 0 | 0 | 0 | 0 | 0 | 0 |
| PF03477 | 91.5541 | 1r1r | 0 | 0 | 0 | 0 | 0 | 0 | 0 | 0 |
| PF03830 | 151.188 | 1ble | 0.13 | 0.2 | 0.2 | 0.2 | 0.067 | 0.2 | 0.13 | 0.27 |
| PF05198 | 75.8462 | 1tif | 0.125 | 0.125 | 0.75 | 0.75 | 0.125 | 0.25 | 0.75 | 0.75 |
| | | mean± | 0.12 | 0.13 | 0.195 | 0.226 | 0.128 | 0.178 | 0.221 | 0.273 |
| | | Std Err | 0.016 | 0.02 | 0.026 | 0.026 | 0.019 | 0.023 | 0.025 | 0.029 |

The graph analysis technique of the present embodiments significantly improves the prediction accuracy. Method II improved the accuracy of method I from 12% to 13% for all proteins and from 19.5% to 22.6% for protein cores. Method IV improved the accuracy of method III from 12.8% to 17.8% for the whole proteins and from 22.1% to 27.3% for the predicted core.

The graph analysis technique of the present embodiments was further applied on an independent test set of 57 proteins with known structures obtained from Vicatos et al. [Vicatos S, Reddy B, Kaznessis Y, “Prediction of distant residue contacts with the use of evolutionary information”, Proteins 2005, 58:935-949]. The test set and the training set were found dissimilar to each other by comparing their MSAs with the COMPASS profile-to-profile alignment method [Sadreyev R, Grishin N, “COMPASS: a tool for comparison of multiple protein alignments with assessment of statistical significance”, J Mol Biol 2003, 326:317-336] using a threshold of 10⁻³.

In the calculations on the test set, when the graph analysis reported less then L/10 predictions, the calculation was repeated starting with the top 10% of scores. This was necessary for no more then five families in predicting contacts within the core.

The results for the test set were compared with the results of the PoCM method of Hamilton et al. [Hamilton N, Burrage K, Ragan M, Huber T: “Protein contact prediction using patterns of correlation”, Proteins 2004, 56:679-684] which integrates basic contact predictions using a neural network. The main inputs to the neural network are a set of 25 measures of correlated mutation between all pairs of residues in two “windows” of size five centered on the given residues. It uses also predicted secondary structure of a protein and different residue classes such as nonpolar-hydrophobic, polar-hydrophilic, acidic or basic. Its accuracy is reported to achieve 30.7% for the top L/10 predictions.

Table 5 demonstrates the L/10 best scores accuracy improvements of the graph analysis procedure on the training set.

TABLE 5

| Without graph analysis | | With graph analysis | |
|---|---|---|---|
| Accuracy protein | Accuracy core | Accuracy protein | Accuracy core |
| 0.12 ± 0.018 | 0.22 ± 0.024 | 0.14 ± 0.020 | 0.24 ± 0.029 |

Table 6 summarizes the L/10 best scores accuracy improvements of the graph analysis procedure on the test set, and the results of the PoCM method. Table 7 hereinafter provides the entire test set with the obtained accuracies with and without the graph analysis of the present embodiments.

TABLE 6

| | Without graph analysis | | With graph analysis | |
|---|---|---|---|---|
| | Accuracy | | Accuracy | |
| | protein | Accuracy core | protein | Accuracy core |
| This work | 0.12 ± 0.018 | 0.24 ± 0.027 | 0.18 ± 0.024 | 0.26 ± 0.030 |
| PoCM | 0.23 ± 0.027 | 0.16 ± 0.021 | — | — |

As demonstrated by Table 6, although PoCM is more accurate on whole proteins it is less accurate then the graph analysis for core regions.

TABLE 7

| | | Without graph analysis | | With graph analysis | |
|---|---|---|---|---|---|
| PFAM ID | L/10 | Protein | Core | Protein | Core |
| PF00021 | 8 | 0.5 | 0.5 | 0 | 0.63 |
| PF00024 | 8 | 0.25 | 0.25 | 0.13 | 0.25 |
| PF00030 | 10 | 0.25 | 0.5 | 0.38 | 0.5 |
| PF00051 | 6 | 0.13 | 0.63 | 0.13 | 0.25 |
| PF00068 | 11 | 0.17 | 0.17 | 0.08 | 0.17 |
| PF00079 | 65 | 0.05 | 0 | 0.05 | 0.03 |
| PF00092 | 26 | 0.39 | 0.06 | 0.56 | 0.06 |
| PF00104 | 12 | 0 | 0.11 | 0.11 | 0.11 |
| PF00105 | 6 | 0.63 | 0.13 | 0.25 | 0.13 |
| PF00109 | 40 | 0.04 | 0.28 | 0.44 | 0.4 |
| PF00121 | 29 | 0.25 | 0.27 | 0.13 | 0.17 |
| PF00160 | 17 | 0.19 | 0.25 | 0.13 | 0.38 |
| PF00169 | 9 | 0 | 0.55 | 0.36 | 0.55 |
| PF00173 | 13 | 0 | 0.5 | 0 | 0.75 |
| PF00175 | 10 | 0 | 0.45 | 0 | 0.55 |
| PF00185 | 21 | 0 | 0.25 | 0 | 0.19 |
| PF00188 | 6 | 0.23 | 0.38 | 0.15 | 0.23 |
| PF00198 | 32 | 0.09 | 0.13 | 0.09 | 0.17 |
| PF00218 | 24 | 0.16 | 0.08 | 0.04 | 0.04 |
| PF00303 | 29 | 0.07 | 0.1 | 0 | 0.03 |
| PF00306 | 11 | 0.09 | 0.36 | 0 | 0.4 |
| PF00340 | 18 | 0.08 | 0.69 | 0.46 | 0.23 |
| PF00349 | 24 | 0.05 | 0.1 | 0.05 | 0.1 |
| PF00401 | 4 | 0 | 0 | 0 | 0 |
| PF00410 | 16 | 0.15 | 0.38 | 0.31 | 0.69 |
| PF00511 | 8 | 0 | 0.25 | 0.63 | 0.75 |
| PF00554 | 21 | 0.06 | 0.29 | 0.29 | 0.29 |
| PF00556 | 6 | 0 | 0 | 0 | 0 |
| PF00595 | 13 | 0.25 | 0.5 | 0.63 | 0.5 |
| PF00615 | 19 | 0.08 | 0.25 | 0.08 | 0.33 |
| PF00732 | 30 | 0.04 | 0.12 | 0.15 | 0.19 |
| PF00754 | 12 | 0.38 | 0.7 | 0.54 | 0.7 |
| PF00759 | 64 | 0.09 | 0.13 | 0.07 | 0.18 |
| PF00775 | 19 | 0.06 | 0.28 | 0.11 | 0.06 |
| PF00787 | 3 | 0.28 | 0.39 | 0.11 | 0.28 |
| PF00809 | 24 | 0.05 | 0 | 0.05 | 0 |
| PF00840 | 33 | 0.07 | 0.07 | 0.12 | 0.12 |
| PF01011 | 5 | 0.25 | 0.25 | 0.25 | 0.5 |
| PF01063 | 41 | 0.07 | 0.11 | 0.14 | 0.11 |
| PF01179 | 53 | 0.1 | 0.07 | 0.12 | 0.12 |
| PF01225 | 11 | 0 | 0 | 0.22 | 0.11 |
| PF01273 | 19 | 0.06 | 0.18 | 0.18 | 0.06 |
| PF01322 | 13 | 0 | 0 | 0 | 0.08 |
| PF01419 | 18 | 0.16 | 0.08 | 0.15 | 0.08 |
| PF01453 | 17 | 0.1 | 0.55 | 0.36 | 0.55 |
| PF01645 | 44 | 0.05 | 0.08 | 0.14 | 0.14 |
| PF01729 | 20 | 0.06 | 0 | 0 | 0.12 |
| PF01820 | 5 | 0.08 | 0.25 | 0.25 | 0.5 |
| PF02234 | 4 | 0 | 0.2 | 0.6 | 0.4 |
| PF02332 | 41 | 0 | 0.04 | 0.04 | 0.04 |
| PF02629 | 16 | 0.2 | 0.2 | 0.1 | 0.3 |
| PF02866 | 20 | 0.06 | 0.06 | 0 | 0 |
| PF02897 | 3 | 0.47 | 0.6 | 0.47 | 0.59 |
| PF02919 | 20 | 0.1 | 0.05 | 0.14 | 0.18 |
| PF03123 | 5 | 0 | 0 | 0 | 0 |
| PF03830 | 18 | 0.07 | 0.27 | 0.2 | 0.27 |
| PF05198 | 9 | 0.13 | 0.63 | 0.25 | 0.63 |
| | mean± | 0.12 | 0.24 | 0.18 | 0.26 |
| | Std Err | 0.018 | 0.027 | 0.024 | 0.03 |

Example 3 demonstrates that the graph analysis procedure of the present embodiments notably improved the accuracy of a basic intra-protein contacts prediction method. It is to be understood that although the procedure was demonstrated here to improve predictions obtained by pair to pair substitution matrix, it is not intended to limit the scope of the present invention to these types of predictions. One of ordinary skills in the art, provided with the details described herein would know how to adjust the graph analysis procedure of the present embodiments for other prediction methods. Thus, the output of any method for contact prediction can be used as the input for the graph construction.

### Example 4

### Prototype Software Apparatus

Prototype software Apparatus has been developed by the present Inventors to implement the method described hereinabove. The apparatus is capable of calculating and interactively analyzing residue correlations obtained using one or more pair the pair-to-pair substitution matrices. The apparatus communicates with a display device so as to provide visualization on protein structures.

The apparatus can estimate the correlations between any pair of amino acids, for any given query sequence of amino acids and for a given MSA. Correlation scores are computed based on the selected substitution matrices and are transmitted to the display device with graphical options for further analysis of the results. The computation time scales is O(N²L²), where N is the number of sequences in the MSA and L is the sequence length.

The input options of the prototype apparatus are flexible in terms of the format of the input data, even though the core calculations are based on MSAs. Acceptable input formats of the prototype apparatus include: user-defined MSAs, Pfam accession number for pre-calculated alignments, single sequences in FASTA format and PDB structures. In the latter two cases, the apparatus automatically makes a Blast search and aligns identified family members using the teachings of Thompson, J., Higgins, D. and Gibson, T., 1994, “CLUSTAL W: improving the sensitivity of progressive multiple sequence alignment through sequence weighting, position-specific gap penalties and weight matrix choice”, Nucl Acids Res, 22, 4673-4680.

The Apparatus can provide the results both graphically and as easily parsed plain text output files containing correlations in matrix or list forms.

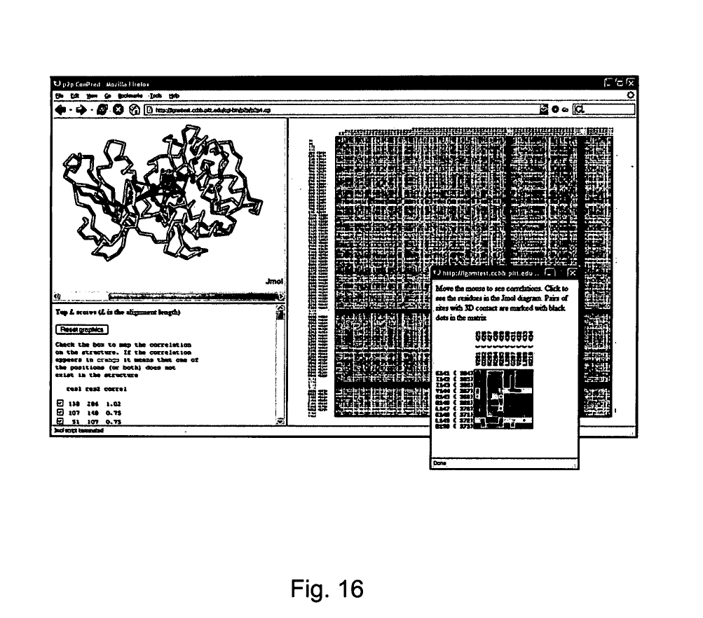

FIG. 16 is an image of a graphical analysis environment provided by the prototype apparatus of the present embodiments. The image exemplifies the use of the apparatus for predicting correlation scores for the catalytic domain of protein kinases.

The graphical analysis environment facilitates the display of correlations between pairs of residues by two-dimensional correlation maps as a function of residue index/types. In the present Example, the correlation map is based on the PFAM seed alignment of the kinases catalytic domain (PF00069). Blue colors in the map indicate high scores and red indicate low scores.

The insert section in FIG. 16 demonstrates enlargement (zoom in) of portions the maps, in response to the user's requests. Black dots on the enlarge portion indicate amino acids with direct contact. Upon a further request, particular pairs of residues of the enlarged maps are highlighted, as shown in the frame on the left side of FIG. 16. This frame shows the three-dimensional structure of a representative member from the family of the query sequence, if such a structure exists. In the present example, the residues that participate in the ten top correlation scores, all located in the central region of the domain, are mapped on the structure of PKC (PDB 1zrz).

Additionally, the graphical analysis environment displays a rank-ordered list of correlated pairs of amino acids, as shown in the lower left frame of FIG. 16.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### CD-ROM Content

The following duplicate CD-ROM is attached herewith:

File information is provided as: File name/bite size/date of creation/machine format/operating system.

CD-ROM1 (6 files):

1. Blockl3-data.txt/1.78 MB/Jun. 28, 2006/Notepad/PC

2. Blockl4-data.txt/4.48 MB/Jun. 28, 2006/Notepad/PC

3. P2Pmat14Inter.txt/1.53 MB/Jun. 28, 2006/Notepad/PC

4. P2Pmat14Intra.txt/1.53 MB/Jun. 28, 2006/Notepad/PC

5. P2Pmat.txt/1.53 MB/Jun. 28, 2006/Notepad/PC

6. P2PmatBuried.txt/1.53 MB/Jun. 28, 2006/Notepad/PC

What is claimed is:

1. A method of predicting putative contacting sites of a target protein, comprising:
providing a substitution matrix representing predetermined probabilities for amino acid pair substitutions;
providing a sequence alignment containing at least a portion of the amino acid sequence of the target protein; and
utilizing said substitution matrix for calculating contact probabilities for pairs of columns in said sequence alignment, thereby predicting the putative contacting sites of at least a first portion of the target protein, said first portion corresponding to a hydrophobic core of the target protein.

2. The method of claim 1, further comprising applying a supplementary algorithm for predicting putative contact sites of at least a second portion of the target protein, said second portion being other than said first portion.

3. Apparatus for predicting putative contacting sites of a target protein, comprising:
an input unit, inputting a sequence alignment containing at least a portion of the amino acid sequence of the target protein;
a contact probability calculation unit, capable of accessing a substitution matrix representing predetermined probabilities for amino acid pair substitutions, said contact probability calculation unit being operable to utilize said substitution matrix for calculating contact probabilities for pairs of columns in said sequence alignment; and
a contact prediction unit, for using said contact probabilities to predict the putative contacting sites of at least a first portion of the target protein, said first portion corresponding to a hydrophobic core of the target protein.

4. The apparatus of claim 3, further comprising a supplementary unit operable to apply a supplementary algorithm for predicting putative contact sites of at least a second portion of the target protein, said second portion being other than said first portion.

5. The method of claim 1, further comprising, using the putative contacting sites for predicting at least a partial three-dimensional structure of the target protein.

6. The method of claim 5, wherein said partial three-dimensional structure corresponds to said hydrophobic core.

7. The method of claim 2, further comprising using said putative contact sites of said at least a second portion of the target protein for predicting a three-dimensional structure of said second portion of the target protein.

8. The method of claim 5, wherein said utilizing said substitution matrix comprises:
constructing a graph having a plurality of nodes, each corresponding to an individual amino acid, and a plurality of edges, each corresponding to a contact between two respective amino acids;
analyzing said graph so as to locate highly connected regions over said graph; and
predicting said at least said first portion of the three-dimensional structure based on said highly connected regions.

9. The method of claim 8, wherein each edge of said plurality of edges is associated with a weight, hence said graph is a weighted graph.

10. The method of claim 8, wherein analyzing said graph comprises updating at least one weight of said graph.

11. The method of claim 10, wherein said updating is by a moving window procedure.

12. The method of claim 10, further comprising iterating said analysis of said graph at least one.

13. Apparatus for predicting at least a partial three-dimensional structure of a target protein, comprising:
an input unit for inputting a sequence alignment containing at least a portion of the amino acid sequence of the target protein; and
a contact probability calculation unit, capable of accessing a substitution matrix representing predetermined probabilities for amino acid pair substitutions, said contact probability calculation unit being operable to utilize said substitution matrix for calculating contact probabilities for pairs of columns in said sequence alignment, so as to predict at least a first portion of the three-dimensional structure of the target protein, said first portion corresponding to a hydrophobic core of the target protein.

14. The apparatus of claim 13, further comprising a supplementary unit operable to apply a supplementary algorithm for predicting three-dimensional structure of at least a second portion of the target protein, said second portion being other than said first portion.

15. The apparatus of claim 13, further comprising: a graph constructor, for constructing a graph having a plurality of nodes, each corresponding to an individual amino acid, and a plurality of edges, each corresponding to a contact between two respective amino acids, said graph constructor being associated with a graph analysis functionality, for locating highly connected regions over said graph and predicting said at least said first portion of the three-dimensional structure based on said highly connected regions.

16. The method of claim 5, wherein said sequence alignment comprises an amino acid sequence of a protein having a known three-dimensional structure.

17. The method of claim 16, wherein said protein is homologous or orthologous to the target protein.

18. The method of claim 16, wherein said sequence alignment comprises two sequences.

19. The method of claim 16, wherein said substitution matrix is utilized for calculating probabilities for substituting contacting pairs of said amino acid sequence with respectively aligned pairs of the target amino acid sequence.

20. The method of claim 19, wherein said contacting pairs occupy at least a hydrophobic core of said known three-dimensional structure of said protein.

21. A readable data storage medium, carrying a substitution matrix comprising a plurality of matrix-elements, each representing a probability for substituting a first respective pair of amino acids with a second respective pair of amino acids, wherein the average of all probabilities represented by matrix-elements corresponding to contacting pairs of amino acids is above a first threshold and the average of all probabilities represented by matrix-elements corresponding to conserved pairs of amino acids is below a second threshold being lower than said first threshold,
wherein a contact between two pairs of amino acids of at least one protein sequence is predictable by extracting a probability represented by a respective matrix-element of the substitution matrix and using said probability for predicting said contact between said two pairs of amino acids.

22. A system comprising the readable data storage medium of claim 21 and a data processor, said data processor being operable to access the substitution matrix and to predict a contact between two pairs of amino acids of at least one protein sequence by extracting a probability represented by a respective matrix-element of the substitution matrix and using said probability for predicting said contact between said two pairs of amino acids.

23. A method of ranking decoy structures of a protein having a known sequence, comprising:
providing a substitution matrix representing predetermined probabilities for amino acid pair substitutions;
providing a sequence alignment containing at least a portion of the amino acid sequence of the target protein; and
utilizing said substitution matrix for assigning a score for each decoy structure, thereby ranking the decoy structures of the protein.

24. The method of claim 5, wherein said substitution matrix comprises a plurality of matrix-elements, and wherein matrix-elements corresponding to conserved amino acids represent low probabilities.

25. The method of claim 5, wherein said sequence alignment comprises at least three sequences.

26. The method of claim 25, further comprising association each sequence of said at least three sequences with a weight, thereby providing a weighted sequence alignment characterized by a plurality of weights.

27. The apparatus of claim 25, further comprising a weighting unit for association each sequence of said at least three sequences with a weight, thereby to provide a weighted sequence alignment characterized by a plurality of weights.

28. The method of claim 26, wherein said contact probabilities are calculated using at least a portion of said plurality of weights.

29. The method of claim 5, wherein said sequence alignment contains at least 10 sequences.

30. The method of claim 5, wherein said sequence alignment contains at least 20 columns.

31. The method of claim 2, wherein said supplementary algorithm comprises residue-residue contacts prediction.

32. The method of claim 2, wherein said supplementary algorithm comprises correlated mutation analysis.

33. The method of claim 2, wherein said supplementary algorithm comprises Monte Carlo folding simulations.

34. The method of claim 2, wherein said supplementary algorithm is capable of utilizing a supplementary substitution matrix.

35. The method of claim 34, wherein said supplementary substitution matrix is a binary matrix.

36. The method of claim 34, wherein said supplementary substitution matrix is a blocks substitution matrix.

37. The method of claim 34, wherein said supplementary substitution matrix is a biophysical complementarity matrix.
